(19) United States
(12) Patent Application Publication
(10) Pub. No.: US 2026/0264358 A1
(43) Pub. Date: Sep. 10, 2026

(54) CORRUGATED PAPERBOARD BOX MAKING MACHINE

(71) Applicant: KABUSHIKI KAISHA ISOWA, Kasugai-shi (JP)

(72) Inventor: Junya YASUDA, Kasugai-shi (JP)

(21) Appl. No.: 19/543,350

(22) Filed: Feb. 18, 2026

(30) Foreign Application Priority Data
Mar. 6, 2025 (JP) 2025-035164

(51) Int. Cl. B31B 50/00; B31B 50/06; B31B 50/14; B31B 50/62; B31B 50/88

(52) U.S. Cl. CPC B31B 50/006; B31B 50/06; B31B 50/14; B31B 50/622; B31B 50/88

(57) ABSTRACT

Provided is a corrugated paperboard box making machine, wherein when a replacement work-free order change is performed, a controller operates to: after completion of a current order, deactivate sheet feed rollers and a grate to stop a sheet feeding operation while continuing the operation of a slotter unit; and after completion of setup works which are preparatory works for a next order, drive the sheet feed rollers and the grate to resume the sheet feeding operation, thereby starting production of the next order. In particular, the controller operates to, during a period from the completion of the current order to the start of the next order, stop the rotation of a feed roll before a sheet setting work in which an operator sets corrugated paperboard sheets in a sheet feeder and to resume the rotation of the feed roll after completion of the sheet setting work.

### RELATED APPLICATIONS

This application claims priority to Japanese Patent application No. JP2025-035164, filed on March 6, 2025, the entire content of which is incorporated herein by reference.

### BACKGROUND OF THE INVENTION

### 1. Field of the Invention

The present invention relates to a corrugated paperboard box making machine, and more particularly to a corrugated paperboard box making machine in which an order change requiring preparatory works is frequently performed in a day.

### 2. Description of the Related Art

Heretofore, there has been known a corrugated paperboard box making machine for producing corrugated paperboard boxes from corrugated paperboard sheets. The box making machine mainly comprises: a sheet feeder for feeding out corrugated paperboard sheets one-by-one; a printer for subjecting the corrugated board sheets to printing; a creaser unit for subjecting the corrugated board sheets to creasing; a slotter unit for subjecting the corrugated board sheets to slotting; a die cutter for subjecting the corrugated board sheets to die-cutting; a folder-gluer for subjecting each of the corrugated board sheets to gluing and folding to form a box-structured corrugated board sheet; and a counter-ejector for ejecting the box-structured corrugated board sheets in units of given batches.

In a factory for producing corrugated paperboard boxes using a box making machine, corrugated paperboard boxes according to a large number of orders received from customers are produced per day while successively switching over from one order to another among the large number of orders. During production of each order, a so-called "order change" is performed before resuming continuous feeding of corrugated paperboard sheets to start the production, wherein the order change involves a preparatory work of adjusting the box making machine to the specifications of corrugated paperboard boxes specified by the order. For the order change, a time (preparation time) is necessary to make preparation for production of a next order (an order immediately after the order change).

Such an order change includes an order change involving a replacement work (i.e., "replacement work-involved order change") and an order change involving no replacement work (i.e., "replacement work-free order change"). Heretofore, the replacement work-involved order change has been commonly performed, but in recent years, from a viewpoint of shortening the preparation time before restarting production, during an order change, attention has recently been directed to the replacement work-free order change.

Here, the "replacement work-free order change" means a case where a work of automatically positioning movable members is performed in each device/unit of the box making machine, and a work of setting corrugated paperboard sheets to be processed in a next order, on a sheet feed table is performed in the sheet feeder, automatically, or manually by an operator. On the other hand, the "replacement work-involved order change" means a case where a replacement work for a printing plate of the printer, and/or a replacement work for a cutting die of the die cutter are performed, in addition to the works performed in the "replacement work-free order change."

Under such circumstances, for example, Patent Document 1 (JP7527625B2) proposes a corrugated paperboard box making machine configured to improve production efficiency of the box making machine by shortening the preparation time required for the replacement work-free order change. In the box making machine described in Patent Document 1, during the period from completion of production of a current order to start of production of a next order, while a slotter is controlled to continue rotating, a sheet feeder is controlled to stop a corrugated paperboard sheet feeding operation, specifically to stop sheet feed rollers, a grate, a kicker, and the like.

### SUMMARY OF THE INVENTION

### Technical Problem

Typically, in the replacement work-free order change, a sheet setting work in which an operator manually sets corrugated paperboard sheets in the sheet feeder, such as a work of manually loading corrugated paperboard sheets onto the sheet feed table of the sheet feeder (manual stacking), or a work of manually aligning corrugated paperboard sheets that have been automatically loaded into the sheet feeder by a sheet loading apparatus, is performed. In the box making machine described in the Patent Document 1, such a sheet setting work is performed in a state in which sheet feed rollers, a grate, a kicker, and the like of the sheet feeder are stopped, while the rotation of a feed roll located in the sheet feeder at a position downstream of these devices/units is continued. Therefore, it has been revealed that it is necessary to provide safety measures for the sheet setting work in the situation where the rotation of the feed roll continues.

Herein, with reference to FIGS. 18A and 18B, the above-mentioned necessity of safety measures in the sheet feeder will be described. FIG. 18A schematically illustrates a sectional view of the sheet feeder as viewed along a feed-out direction of the corrugated paperboard sheet, and FIG. 18B schematically illustrates a sectional view of the sheet feeder taken along the line A1–A1 in FIG. 18A. As shown in FIGS. 18A and 18B, the sheet feeder 2 mainly comprises: a sheet feed table 12b on which corrugated paperboard sheets (not shown) are stacked; sheet feed rollers 20 for feeding out a lowermost corrugated paperboard sheet among the corrugated paperboard sheets stacked on the sheet feed table 12b; a feed roll 24 composed of a pair of upper and lower roll members and for feeding the corrugated paperboard sheet fed out from the sheet feed rollers 20 toward a printer (not shown) located downstream of the sheet feeder 2; a feed roll cover 24a covering the upper roll member of the feed roll member 24; and a frame 24b holding the feed roll 24, etc.

In the sheet feeder 2, in order to enable the corrugated paperboard sheet fed out from the sheet feed rollers 20 to be fed out toward the printer via the feed roll 24, a gap SP extending in a width direction and allowing said corrugated paperboard sheet to pass therethrough is formed between an upper surface of the sheet feed table 12b, below which the sheet feed rollers 20 are provided, and a lower end of the feed roll cover 24a covering the upper roll member of the feed roll 24. Thus, when an operator performs the sheet setting work during the replacement work-free order change, there may be a case where the operator's finger inadvertently enters the gap SP of the sheet feeder 2. In such a case, if the feed roll 24 continues rotating as in the technique described in Reference 1, there is a possibility that the finger inserted through the gap SP can come into contact with the rotating feed roll 24.

As a measure against such a technical problem, for example, it is conceivable to provide an openable-closable door that covers the entire gap SP to the sheet feeder 2. However, since the sheet feeder 2 is equipped with many movable devices, such as the sheet feed rollers 20, the feed roll 24, and a grate (not shown in FIGS. 18A or 18B), it is difficult to secure, in the sheet feeder 2, a location for installing such an openable-closable door, and therefore this measure cannot be said to be practical.

The present invention has been made to solve the above technical problem, and an object thereof is to provide a corrugated paperboard box making machine capable of ensuring safety when an operator performs a work of setting up corrugated paperboard sheets in a sheet feeder during a replacement work-free order change.

### Solution to Problem

In order to achieve the above object, the present invention provides a corrugated paperboard box making machine, comprising: a sheet feeder that feeds out corrugated paperboard sheets one by one; a printer that prints on the corrugated paperboard sheets; a creaser unit that performs creasing on the corrugated board sheets; a slotter unit that performs slotting on the corrugated board sheets; and a controller configured to control the sheet feeder, the printer, the creaser unit, and the slotter unit, wherein: the sheet feeder comprises a feed-out mechanism that feeds out a lowermost corrugated paperboard sheet among corrugated paperboard sheets stacked in the sheet feeder, a feed roll that further feeds out the corrugated paperboard sheet fed out from the feed-out mechanism, a feed-out mechanism drive motor that drives the feed-out mechanism, and a feed roll drive motor that rotationally drives the feed roll; and the slotter unit comprises an upper slotter to which a slotter blade that performs slotting on the corrugated paperboard sheet is attached, a lower slotter formed with a groove that is fittable with the slotter blade of the upper slotter, and a slotter drive motor that rotationally drives the upper and lower slotters, wherein the controller is configured, when performing a replacement work-free order change in the corrugated paperboard box making machine, to: after completion of production of a current order, control the feed-out mechanism drive motor to deactivate the feed-out mechanism so as to stop a corrugated paperboard sheet feeding operation, while controlling the slotter drive motor to enable the upper and lower slotters to continue rotating; after completion of setup works which are preparatory works for production of a next order in the sheet feeder, the printer, the creaser unit, and the slotter unit, control the feed-out mechanism drive motor to drive the feed-out mechanism so as to resume the corrugated paperboard sheet feeding operation and start production of the next order; and during a period from the completion of production of the current order to the start of production of the next order, control the feed roll drive motor to stop rotation of the feed roll before a sheet setting work in which an operator sets corrugated paperboard sheets in the sheet feeder and to resume the rotation of the feed roll after completion of the sheet setting work.

In the present invention having the above feature, during the replacement work-free order change, after completion of production of a current order, the feed-out mechanism is deactivated to stop the sheet feeding operation, while the slotter unit is maintained in an activated state, and then after setup works, which are preparatory works for a next order, has been completed in the box making machine, the feeding mechanism is driven to resume the sheet feeding operation, thereby starting production of the next order. Particularly in the present invention, during the period from the completion of production of the current order to the start of production of the next order, the rotation of the feed roll is stopped before the sheet setting work in which an operator sets corrugated paperboard sheets in the sheet feeder, and the rotation of the feed roll is resumed after the completion of the sheet setting work. Thus, since the feed roll is in a rotation-stopped state when the operator starts performing the sheet setting work, it becomes possible to ensure safety of the operator during the sheet setting work. Specifically, even if the operator's finger inadvertently enters the gap SP of the sheet feeder (see FIGS. 18A and 18B) during the sheet setting work, and comes into contact with the feed roll, it is possible to reliably prevent injury to the operator's finger.

Preferably, in the present invention, the controller is configured to control the feed roll drive motor to resume the rotation of the feed roll, after the completion of the sheet setting work and before driving the feed-out mechanism to resume the sheet feeding operation.

According to the present invention having this feature, it becomes possible to resume the rotation of the feed roll having a relatively large moment of inertia, early before the start of production of the next order, thereby preventing a delay in resuming production after the order change.

Preferably, in the present invention, the corrugated paperboard box making machine further comprises a die cutter that subjects the corrugated paperboard sheets to die-cutting, wherein the controller is configured to control the feed roll drive motor such that the rotation of the feed roll is stopped before a last corrugated paperboard sheet of the current order passes through the die cutter.

According to the present invention having this feature, it becomes possible to promptly stop the rotation of the feed roll. Thus, since the feed roll is in the rotation-stopped state before the start of the order change, i.e., the feed roll has already been stopped at the time of the order change in which the setup work of each device/unit is performed, it is not necessary to confirm that the feed roll is in the rotation-stopped state in order to guarantee safety of the operator during the sheet setting work.

Preferably, in the present invention, the controller is configured to determine whether or not the rotation of the feed roll has been stopped, and to permit performing the setup works which are the preparation works, after determining that the rotation of the feed roll has been stopped.

According to the present invention having this feature, since it is not permitted to perform the setup work of each device/unit until it is determined that the rotation of the feed roll has been stopped, it becomes possible to effectively ensure safety of the operator during the sheet setting work.

Preferably, in the present invention, the sheet feeder further comprises: a sheet feed table on which corrugated paperboard sheets are stacked; a back guide that restricts rear ends of the corrugated paperboard sheets on the sheet feed table; and a back guide moving device that moves the back guide in a feed-out direction of the corrugated paperboard sheet, and wherein the controller is configured to control the back guide moving device to move the back guide to a position according to a dimension of corrugated paperboard sheets of the next order in the feed-out direction, within a period during which the controller operates, via the feed roll drive motor, to cause the feed roll to undergo decelerating rotation so as to stop the feed roll.

According to the present invention having this feature, since the back guide is moved within a period during which the rotation of the feed roll is decelerated and finally stopped, it becomes possible to shorten a preparation time during the order change.

Preferably, in the present invention, the sheet feeder further comprises: a sheet feed table on which corrugated paperboard sheets are stacked; a side guide that restricts opposite ends of the corrugated paperboard sheets on the sheet feed table in a width direction; and a side guide moving device that moves the side guide in the width direction, and wherein the controller is configured to control the side guide moving device to move the side guide to a position according to a dimension of corrugated paperboard sheets of the next order in the width direction, within a period during which the controller operates, via the feed roll drive motor, to cause the feed roll to undergo decelerating rotation so as to stop the feed roll.

According to the present invention having this feature, since the side guide is moved within the period during which the rotation of the feed roll is decelerated and finally stopped, it becomes possible to shorten the preparation time during the order change.

Preferably, in the present invention, the sheet feeder further comprises: a sheet feed table on which corrugated paperboard sheets are stacked; a back guide that restricts rear ends of the corrugated paperboard sheets on the sheet feed table; a side guide that restricts opposite ends of the corrugated paperboard sheets on the sheet feed table in a width direction; a back guide moving device that moves the back guide in a feed-out direction of the corrugated paperboard sheet; and a side guide moving device that moves the side guide in the width direction, and wherein the controller is configured to: control the back guide moving device to move the back guide to a position according to a dimension of corrugated paperboard sheets of the next order in the feed-out direction and control the side guide moving device to move the side guide to a position according to a dimension of corrugated paperboard sheets of the next order in the width direction, within a period during which the controller operates, via the feed roll drive motor, to cause the feed roll to undergo decelerating rotation so as to stop the feed roll; and control moving speeds of the back guide and the side guide via the back guide moving device and the side guide moving device, respectively, such that the movements of the back and side guides are completed at a timing when the rotation of the feed roll is stopped via the feed roll drive motor.

According to the present invention having this feature, the respective moving speeds of the back and side guides are controlled such that the movements of the back and side guides are completed at the timing when the rotation of the feed roll is stopped. Thus, since the feed roll is the rotation-stopped state when the operator starts the sheet setting work, i.e., when the movements of the back and side guides have been completed, it becomes possible to ensure safety during the sheet setting works. Further, since the movements of the back and side guides have already been completed when the rotation of the feed roll is stopped, it becomes possible to shorten the preparation time during the order change.

Preferably, in the present invention, the corrugated paperboard box making machine further comprises a notification device that notifies that the feed roll is undergoing decelerating rotation under the control of the feed roll drive motor by the controller.

According to the present invention having this feature, the fact that the feed roll is undergoing decelerating rotation is notified to the operator. This allows the operator to figure out the rotational state of the feed roll. Thus, the operator can easily determine whether or not the sheet feeder is in a state in which corrugated paperboard sheets can be set therein.

Preferably, in the present invention, the corrugated paperboard box making machine further comprises a notification device that notifies that the rotation of the feed roll has been stopped under the control of the feed roll drive motor by the controller.

According to the present invention having this feature, the fact that the rotation of the feed roll has been stopped is notified to the operator. This allows the operator to figure out the rotational state of the feed roll. Thus, the operator can easily determine whether or not the sheet feeder is in a state in which corrugated paperboard sheets can be set therein.

In a preferred embodiment of the present invention, the corrugated paperboard box making machine further comprises: a die cutter that subjects the corrugated board sheets to die-cutting; a folder-gluer that subjects each of the corrugated board sheets to gluing and folding to form a box-structured corrugated board sheet; and a counter-ejector that eject the box-structured corrugated board sheets in units of given batches.

The corrugated paperboard box making machine according to the present invention makes it possible to ensure safety when an operator performs the work of setting corrugated paperboard sheets in the sheet feeder during the replacement work-free order change.

### BRIEF DESCRIPTION OF THE DRAWINGS

FIG. 1 is a block diagram schematically showing a corrugated paperboard box making machine according to an embodiment of the present invention.

FIG. 2 is a schematic side view showing the corrugated paperboard box making machine according to the embodiment of the present invention.

FIG. 3 is a perspective view showing a sheet feeder of the corrugated paperboard box making machine according to the embodiment of the present invention.

FIG. 4 is a sectional view of the sheet feeder of the corrugated paperboard box making machine according to the embodiment of the present invention, taken along the line III-III in FIG. 3, wherein a grate is in a raised position.

FIG. 5 is a sectional view of the sheet feeder of the corrugated paperboard box making machine according to the embodiment of the present invention, taken along the line III-III in FIG. 3, wherein the grate is in a lowered position.

FIG. 6 is a front view of the sheet feeder of the corrugated paperboard box making machine according to the embodiment of the present invention.

FIG. 7 is a block diagram showing a controller and devices/units related thereto of the corrugated paperboard box making machine according to the embodiment of the present invention.

FIG. 8 is a flowchart showing an order change process according to a first embodiment of the present invention.

FIG. 9 is a flowchart showing a setup work of the sheet feeder according to the first embodiment of the present invention.

FIG. 10 is a flowchart showing a setup work of a slotter unit according to the first embodiment of the present invention.

FIG. 11 is a time chart showing a setup work of the sheet feeder during an order change according to the first embodiment of the present invention.

FIG. 12 is a flowchart showing an order change process according to a second embodiment of the present invention.

FIG. 13 is a time chart showing the setup work of the sheet feeder during an order change according to the second embodiment of the present invention.

FIG. 14 is a time chart showing another example of the setup work of the sheet feeder during the order change according to the second embodiment of the present invention.

FIG. 15 is a flowchart showing an order change process according to a third embodiment of the present invention.

FIG. 16 is a flowchart showing a setup work of the sheet feeder according to the third embodiment of the present invention.

FIG. 17 is a flowchart showing an order change process according to a fourth embodiment of the present invention.

FIG. 18A is a schematic diagram of a sheet feeder for explaining a technical problem to be solved by the present invention.

FIG. 18B is a schematic diagram of a sheet feeder for explaining a technical problem to be solved by the present invention.

### DETAILED DESCRIPTION OF THE PREFERRED EMBODIMENTS

With reference to the drawings, a corrugated paperboard box making machine according to an embodiment of the present invention will now be described.

### Configuration of Corrugated Paperboard Box Making Machine

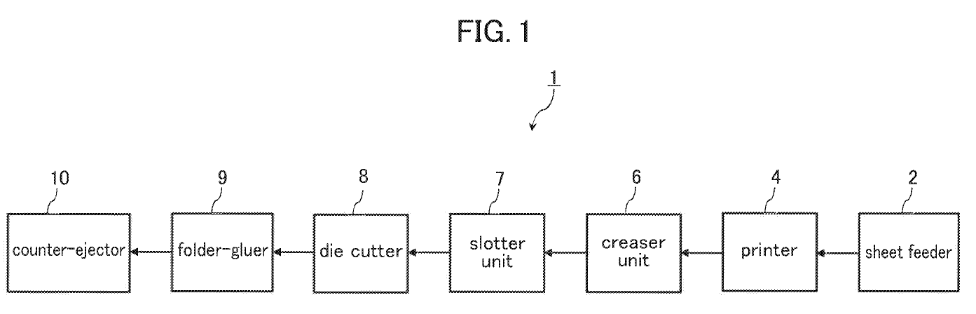

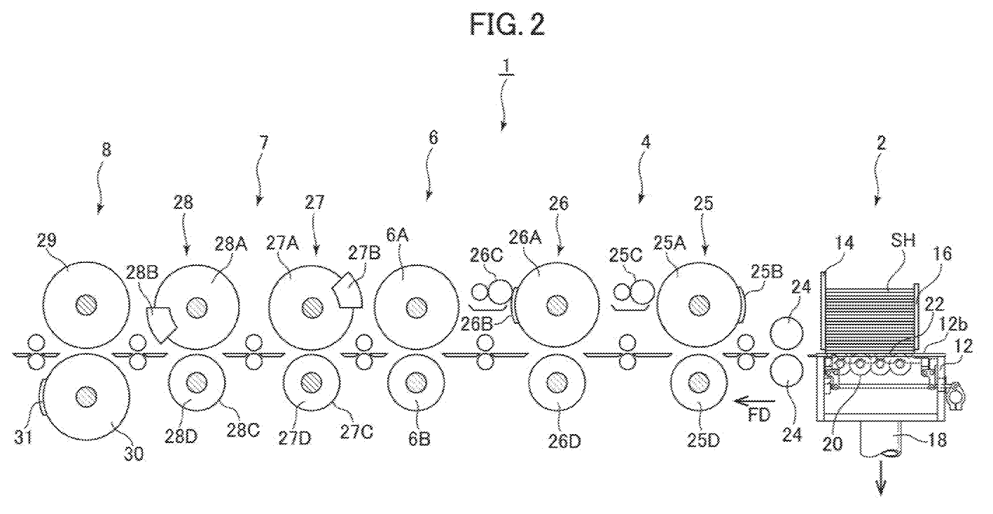

First, with reference to FIGS. 1 and 2, an overall configuration of the corrugated paperboard box making machine according to the embodiment of the present invention will be described. FIG. 1 is a block diagram schematically showing the corrugated paperboard box making machine according to this embodiment, and FIG. 2 is a schematic side view showing the corrugated paperboard box making machine according to this embodiment.

As shown in FIGS. 1 and 2, the corrugated paperboard box making machine 1 according to the embodiment of the present invention comprises: a sheet feeder 2 for feeding corrugated paperboard sheets SH one by one; a printer 4 for subjecting the corrugated paperboard sheets SH to printing; a creaser unit 6 for subjecting the corrugated paperboard sheets SH to creasing; a slotter unit 7 for subjecting the corrugated paperboard sheets SH to slotting; and a die cutter 8 for subjecting the corrugated paperboard sheets SH to die-cutting. In addition to these devices/units, the box making machine 1 further comprises: a folder-gluer 9 for subjecting each of the corrugated paperboard sheets SH to gluing and folding to form a box-structured corrugated board sheet; and a counter-ejector 10 for ejecting the box-structured corrugated board sheets SH in units of given batches, which are arranged downstream of the die cutter 8, as shown in FIG. 1.

Here, in the corrugated paperboard box making machine according to this embodiment, there may be a case where the die cutter 8 is omitted, differently from the above-mentioned box making machine. In this case, the folder gluer 9 and the counter-ejector 10 are provided downstream of the slotter unit 7.

The sheet feeder 2 comprises a suction box 12 formed as a housing, wherein a plurality of corrugated paperboard sheets SH produced by a corrugator (not shown) are stacked on a sheet feed table 12b forming an upper surface of the suction box 12 and between a front gate 14 and a back guide 16. The front gate 14 is disposed to allow the stacked corrugated paperboard sheets SH to be fed out one by one through a gap between the sheet feed table 12b and the front gate 14. The back guide 16 is configured to be movable with respect to the front gate 14 in a feed-out direction FD of the corrugated paperboard sheet SH, whereby the sheet feeder 2 can accommodate various corrugated paperboard sheets SH which are different in length along the feed-out direction FD. Further, a suction device 18 (only a portion thereof is illustrated in FIG. 2) is attached to a lower portion of the suction box 12. The suction device 18 is configured to suck air inside the suction box 12.

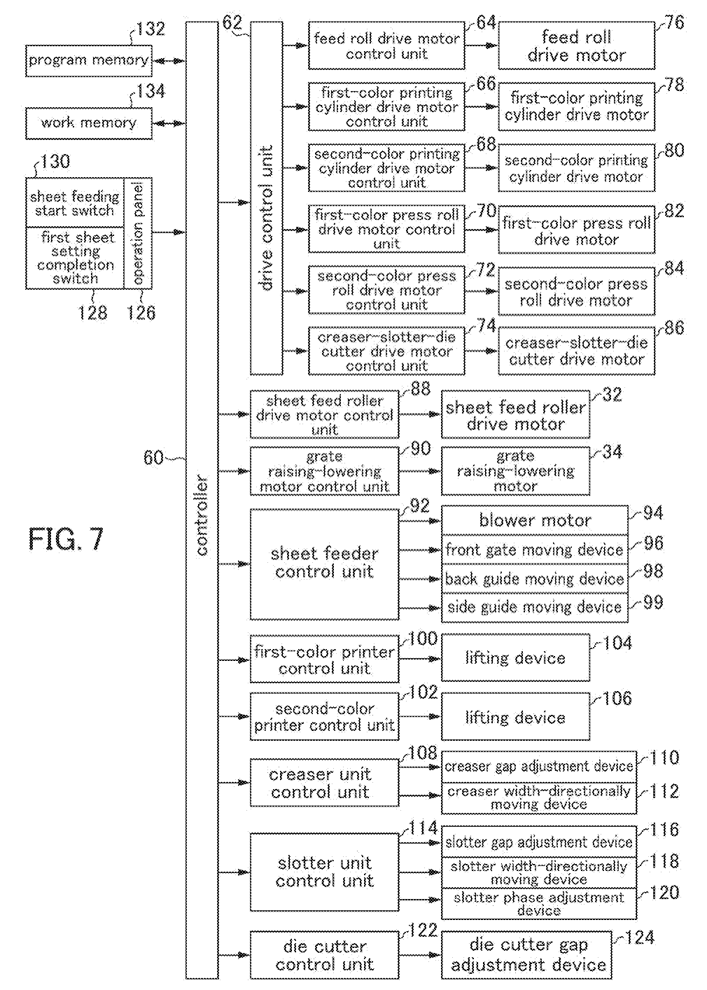

The sheet feeder 2 further comprises: a plurality of sheet feed rollers 20 arranged along each of the feed-out direction FD and a direction orthogonal thereto; and a grate 22 that is a raisable-lowerable member formed as a plate-shaped member extending along each of the feed-out direction FD and the direction orthogonal thereto and configured to be raisable and lowerable with respect to the sheet feed rollers 20. The plurality of sheet feed rollers 20 and the grate 22 are provided in an upper portion of the suction box 12 and constitute a part of the upper surface of the suction box 12. When the grate 22 is lowered below the sheet feed rollers 20, the sheet feed rollers 20 come into contact with the lowermost corrugated paperboard sheet SH among the plurality of stacked corrugated paperboard sheets SH, whereby rotation of the sheet feed rollers 20 is transmitted to the lowermost corrugated paperboard sheet SH, and therefore the lowermost corrugated paperboard sheet SH is fed out toward a feed roll 24 located forward of the sheet feed rollers 20. In this case, when the corrugated paperboard sheet SH fed out by the sheet feed rollers 20 reaches the feed roll 24, the feed roll 24 further feed out the corrugated paperboard sheet SH toward the printer 4 located forward thereof. On the other hand, when the grate 22 is raised above the sheet feed rollers 20, the sheet feed rollers 20 becomes out of contact with the corrugated paperboard sheet SH, and thus the rotation of the sheet feed rollers 20 is no longer transmitted to the corrugated paperboard sheet SH. Here, the feed roll 24 is driven by a feed roll drive motor 76 (see FIG. 7).

The printer 4 comprises two printing units 25 and 26. The printing unit 25 (26) comprises a printing cylinder 25A (26A), a printing plate 25B (26B), an ink application mechanism 25C (26C), and a press roll 25D (26D). The printing plate 25B (26B) has a given printing pattern and is attached to an outer peripheral surface of the printing cylinder 25A (26A). The ink application mechanisms 25C, 26C are configured to apply different-colored inks for the respective printing units. The printer 4 subjects the corrugated paperboard sheet SH to two-color printing by using the two printing units 25, 26, and supplies the printed corrugated paperboard sheet SH to the creaser unit 6.

The printing unit 25 (26) comprises a lifting device 104 (106) (see FIG. 7) for separating the printing cylinder 25A (26A) from a conveyance line, so as to allow the corrugated paperboard sheet SH to pass through without being subjected to printing (non-printing mode), or so as to replace the printing plate 25B (26B) in the non-printing mode. The lifting device 104 (106) is configured to switchably move the printing cylinder 25A (26A) between a lower use position and an upper standby position.

Here, the printing cylinder 25A (26A) of the printing unit 25 (26) is driven by a printing cylinder drive motor 78 (80) (see FIG. 7), and the press roll 25D (26D) is driven by a press roll drive motor 82 (84) (see FIG. 7).

The creaser unit 6 comprises a pair of creasing rolls 6A, 6B arranged one above the other to subject the corrugated paperboard sheet SH to creasing.

The slotter unit 7 comprises two slotters 27, 28 to subject the corrugated paperboard sheet SH to slotting. In order to subject the corrugated paperboard sheet SH to slotting, the slotter 27 (28) comprises an upper slotter 27A (28A) to which a slotter blade 27B (28B) is attached, and a lower slotter 27D (28D) formed with a groove 27C (28C) that is fittable with the slotter blade 27B (28B).

The die cutter 8 comprises a die cylinder 30 and an anvil cylinder 29 arranged across a conveyance path. A single cutting die 31 for subjecting the corrugated paperboard sheet SH to die-cutting is attached to a plate-shaped member such as plywood veneer, and this plate-shaped member is wrapped around an outer circumferential surface of the die cylinder 30. During an order change, the cutting die 31 is replaceable with another cutting die having a punching pattern according to the order.

The creaser unit 6, the two slotters 27, 28, and the die cutter 8 described above are driven by a creaser-slotter-die cutter drive motor 86 (see FIG. 7). The creaser-slotter-die cutter drive motor 86 is equivalent to an example of "slotter drive motor" set forth in the appended claims.

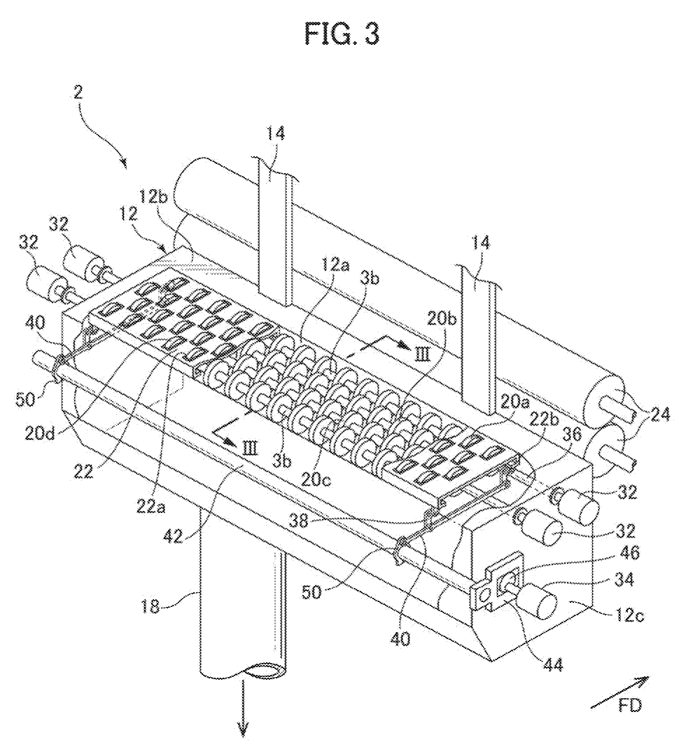

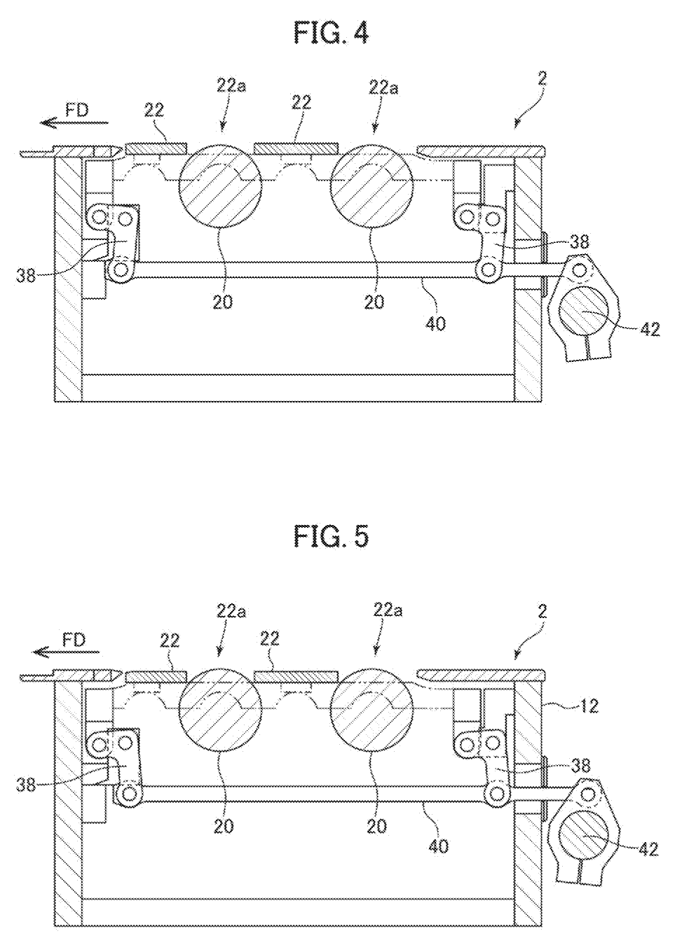

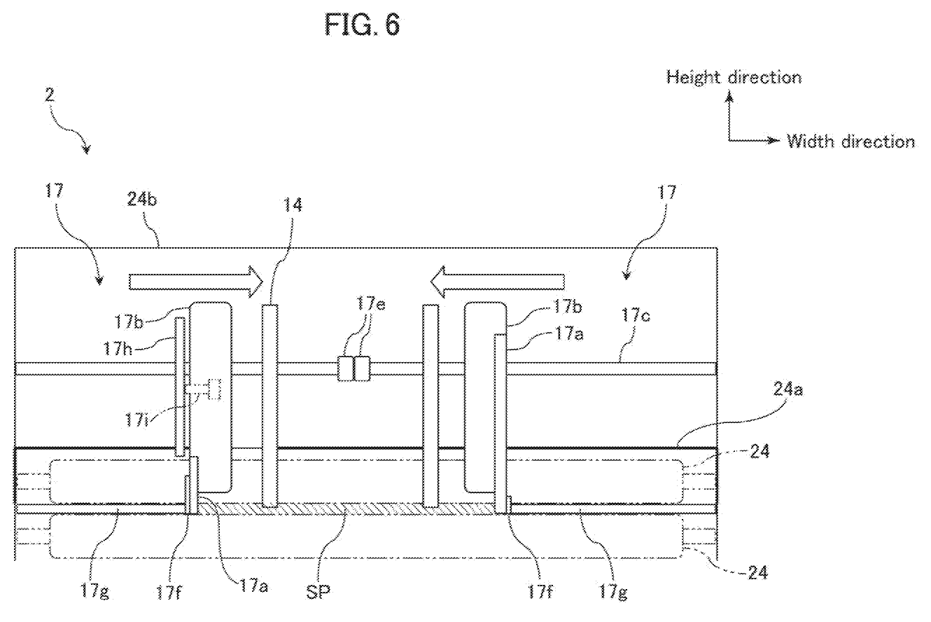

Next, with reference to FIGS. 3 to 6, a specific structure of the sheet feeder 2 of the corrugated paperboard box making machine 1 according to the embodiment of the present invention will be described. FIG. 3 is a perspective view showing the sheet feeder of the corrugated paperboard box making machine according to the embodiment of the present invention. FIG. 4 is a sectional view of the sheet feeder of the corrugated paperboard box making machine according to the embodiment of the present invention, taken along the line III-III in FIG. 3, wherein the grate is in a raised position, and FIG. 5 is a sectional view of the sheet feeder of the corrugated paperboard box making machine according to the embodiment of the present invention, taken along the line III-III in FIG. 3, wherein the grate is in a lowered position. FIG. 6 is a front view of the sheet feeder of the corrugated paperboard box making machine according to the embodiment of the present invention.

As shown in FIG. 3, the suction box 12 is formed as a housing by right and left side walls 12c, the sheet feed table (placement surface) 12b as the upper surface of the suction box 12, and others, and the suction device 18 (only a part thereof is shown in FIG. 3) is attached to the lower portion of the suction box 12, and configured to suck a corrugated paperboard sheet SH (see FIG. 2) placed on the sheet feed table 12b downwardly. The front gate 14 is disposed on the downstream side of the suction box 12 such that it extends upwardly at right angle. The front gate 14 is positionally adjustable in an up-down direction, whereby a distance between a lower end of the front gate 14 and the sheet feed table 12b of the suction box 12 can be adjusted in accordance with the thickness of the corrugated paperboard sheet SH. Further, the feed roll 24 is composed of a pair of upper and lower roll members provided downstream of the suction box 12 across a height position of the upper surface of the suction box 12. A plurality of corrugated paperboard sheets SH are set in a state in which they are stacked on the sheet feed table 12b of the suction box 12, and the stacked corrugated paperboard sheets SH are fed out toward the downstream side one by one in order from the lowermost one, and taken into a gap between the roll members of the feed roll 24.

In an upper portion of the suction box 12, there are provided: the plurality of sheet feed rollers 20 (20a, 20b, 20c, and 20d) for feeding out the lowermost corrugated paperboard sheet SH among the stacked corrugated paperboard sheets SH, toward the feed roll 24; and the grate 22, which is configured such that a protrusion amount thereof with respect to the plurality of sheet feed rollers 20 is adjusted through a raising-lowering movement thereof, whereby the grate 22 can adjust contact and separation between the plurality of sheet feed rollers 20 and the lowermost corrugated paperboard sheet SH. Specifically, the suction box 12 has an opening 12a formed in the sheet feed table 12b, and the plurality of sheet feed rollers 20 and the grate 22 are arranged in this opening 12a. Further, a plurality of sheet feed roller drive motors 32, which are servo motors each configured to drive a respective one of the plurality of sheet feed rollers 20, and a grate raising-lowering motor 34, which is a servo motor configured to drive the grate 22, are arranged on the side of the suction box 12.

The plurality of sheet feed rollers 20 have four drive shafts 36, and the sheet feed roller drive motors 32 are coupled, respectively, to the four drive shafts 36, whereby each of the four drive shafts 36 can be rotationally driven independently. Further, the sheet feed rollers 20 are configured to protrude above the grate 22 through the after-mentioned openings 22a of the grate 22 and appear in the opening 12a of the suction box 12 (see FIG. 5), or to be positioned below the grate 22 (see FIG. 4), according to the raising-lowering movement of the grate 22.

As shown in FIGS. 4 and 5, the grate 22 is a plate-shaped member disposed in the opening 12a of the suction box 12. The plate-shaped grate 22 is formed with a plurality of openings 22a each penetrating therethrough to receive respective ones of the sheet feed rollers 20 (20a, 20b, 20c, 20d) so as to avoid contact with the sheet feed rollers 20 during the raising-lowering movement thereof. The plate-shaped grate 22 is connected to a pivot shaft 42 via four L-shaped members 38, 38 arranged, respectively, in the vicinities of four corners thereof, two arms 40, and others. Specifically, two U-shaped claw portions 22b are formed at opposite ends of the plate-shaped grate 22 in a forward-backward direction, and the L-shaped members 38, the arms 40, and others for realizing the raising-lowering movement of the grate 22 are connected via the claw portions 22b.

A swinging member 44 is attached to the end of the pivot shaft 42 of the grate 22. An eccentric cam 46 is attached to the swinging member 44, and the grate raising-lowering motor 34, which is a servo motor, is attached to the eccentric cam 46. The eccentric cam 46 is formed in a circular shape and is configured to be rotated about a rotational axis that is eccentric with respect to a rotational axis of the grate raising-lowering motor 34. The swinging member 44 is configured to swing about the pivot shaft 42 according to the movement of the eccentric cam 46. The resulting swinging movement of the swinging member 44 is transmitted to the pivot shaft 42. The pivot shaft 42 is connected to the arms 40 each arranged below the grate 22 via a connector 50. The arms 40 are arranged below the grate 22 to extend in the feed-out direction FD of the corrugated paperboard sheet SH, and are connected to the grate 22 via the L-shaped members 38 arranged in the vicinities of the four corners of the grate 22. When the arms 40 are moved in the feed-out direction FD according to the rotation of the pivot shaft 42, one side of each of the L-shaped members 38 connected to the grate 22 is raised, whereby the grate 22 is raised to the raised position illustrated in FIG. 4. Conversely, when the arms 40 are moved in a direction opposite to the feed-out direction FD according to the rotation of the pivot shaft 42, the side of each of the L-shaped members 38 connected to the grate 22 is pushed downwardly, whereby the grate 22 is lowered to the lowered position illustrated in FIG. 5.

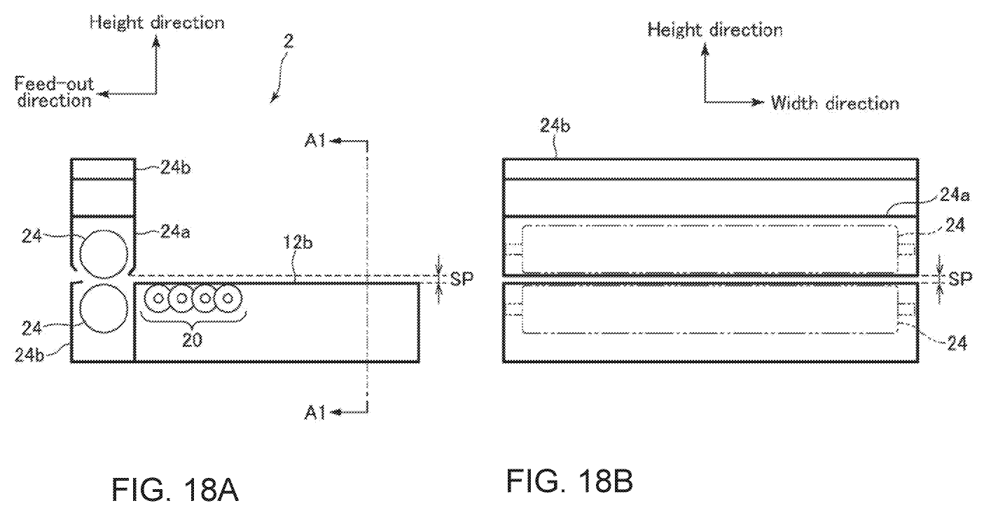

Next, with reference to FIG. 6, a side guide (not shown in FIGS. 2 to 5) of the sheet feeder 2 will be described. As shown in FIG. 6, the sheet feeder 2 comprises a side guide 17 composed of a pair of right and left guide members arranged, respectively, on left and right sides with respect to a machine center, in addition to the above-mentioned front gate 14 and the back guide 16. The side guide 17 is provided on the upstream side of the front gate 14, a feed roll cover 24a covering the feed roll 24, a frame 24b holding the feed roll 24 and others (see also FIGS. 18A and 18B for the feed roll cover 24a).

Specifically, each of the right and left guide members of the side guide 17 comprises: a guide portion 17a for positioning corrugated paperboard sheets SH loaded on the sheet feed table 12b, in a width direction (right-left direction) of the machine; a moving block 17b attached to the guide portion 17a; a screw shaft 17c connected to the moving block 17b via a nut member (not shown); and a bearing 17e fixed to one end of the screw shaft 17c. The other end of the screw shaft 17c is connected to a side guide moving device 99 (FIG. 7), which serves as a drive motor. Thus, when the side guide moving device 99 rotationally drives the screw shaft 17c, the guide portion 17a, etc., move in the width direction (indicated by an outline arrow in FIG. 6).

Further, a Cablebear 17g (that is a "registered trademark"; the same applies hereinafter) is connected to the guide portion 17a of each of the guide members of the side guide 17 via a connecting member 17f. Thus, when the guide portion 17a is moved as mentioned above, the Cablebear 17g is moved in the same direction as that of the guide portion 17a. Such a Cablebear 17g can cover the above-mentioned gap SP (see also FIGS. 18A and 18B) between the sheet feed table 12b and the feed roll cover 24a. However, as shown in FIG. 6, the Cablebear 17g can cover the gap SP only in a range from the end of a frame of the sheet feeder 2 to a displaced position of the guide portion 17a, i.e., it cannot fully cover the gaps SP in the width direction of the machine. Therefore, it is difficult to solve the technical problem described in the section "Technical Problem" only by the Cablebear 17g of the side guide 17. Accordingly, it can be said that further consideration is necessary to ensure safety of work during the replacement work-free order change.

It should be noted that a side jogger 17h for pressing the corrugated paperboard sheets SH stacked on the sheet feed table 12b against the guide portion 17a of the right guide member to align positions of the opposite ends of the corrugated paperboard sheets SH is connected to the moving block 17b of the left guide member via an air cylinder 17i.

Next, with reference to FIG. 7, a controller and devices/units related thereto of the corrugated paperboard box making machine 1 according to this embodiment will be described. FIG. 7 is a block diagram showing the controller and devices/units related thereto of the corrugated paperboard box making machine according to this embodiment.

As shown in FIG. 7, the corrugated paperboard box making machine 1 according to this embodiment comprises a controller 60. The box making machine 1 is configured such that the above-mentioned sheet feeder 2, printer 4, creaser unit 6, slotter unit 7, die cutter 8, and others are controlled by the controller 60.

Specifically, the controller 60 is configured to send drive instructions, respectively, to a feed roll drive motor control unit 64, printing cylinder drive motor control units 66, 68 for the two (first-color and second-color) printing units 25, 26, press roll drive motor control units 70, 72, and a creaser-slotter-die cutter drive motor control unit 74, via a drive control unit 62, thereby controlling the corresponding drive motors. More specifically, the feed roll drive motor control unit 64 controls the feed roll drive motor 76; the printing cylinder drive motor control units 66, 68 control the printing cylinder drive motors 78, 80, respectively; the press roll drive motor control units 70, 72 control the press roll drive motors 82, 84, respectively; and the creaser-slotter-die cutter drive motor control unit 74 controls the creaser-slotter-die cutter drive motor 86.

Next, the controller 60 controls the sheet feed roller drive motor 32 via a sheet feed roller drive motor control unit 88 to rotate the sheet feed rollers 20, and controls the grate raising-lowering motor 34 via a grate raising-lowering motor control unit 90 to raise and lower the grate 22.

Here, during production of one order, the controller 60 operates to synchronously rotate all rolls for conveying the corrugated paperboard sheets SH, i.e., respective rolls of the feed roll 24, the printer 4, the creaser unit 6, the slotter unit 7, and the die cutter 8, such that the circumferential speeds of these rolls coincide with each other, via the drive control unit 62, and simultaneously controls the operations of the sheet feed rollers 20 and the grate 22 such that one corrugated paperboard sheet SH is fed in synchronization with 360-degree rotation of each processing roll such as the printing cylinders 25A, 26A.

Further, the controller 60 controls, via a sheet feeder control unit 92, a blower motor 94 of the suction device 18, a front gate moving device 96, a back guide moving device 98, and a side guide moving device 99, thereby performing a setup work of the sheet feeder 2.

Similarly, the controller 60 controls, via printer control units 100, 102 for the two (first-color and second-color) printing units 25, 26, the lifting devices 104, 106, thereby performing a setup work of the two printing units 25, 26 of the printer 4.

Similarly, the controller 60 controls, via a creaser unit control unit 108, a creaser gap adjustment device 110 and a creaser width-directionally moving device 112, thereby performing a setup work of the creaser unit 6.

Similarly, the controller 60 controls, via a slotter unit control unit 114, a slotter gap adjustment device 116, a slotter width-directionally moving device 118, and a slotter phase adjustment device 120, thereby performing a setup work of the slotter unit 7.

Similarly, the controller 60 controls, via a die cutter control unit 122, a die cutter gap adjustment device 124, thereby performing a setup work of the die cutter 8.

The above-mentioned creaser gap adjustment device 110, creaser width-directional moving device 112, slotter gap adjustment device 116, and slotter width-directional moving device 118 are described in, e.g., JP 2004-291470 A. Further, the slotter phase adjustment device 120 is described in, e.g., JP 2002-67190 A.

An operation panel 126 is connected to the controller 60, which comprises a plurality of operation switches for performing operations on each device/unit. The operation switches include a "first sheet setting completion switch 128," which is operated when at least one corrugated paperboard sheet SH has been set on the sheet feed table 12b, and a "sheet feeding start switch 130," which is operated to start continuous feeding of corrugated paperboard sheets set on the sheet feed table 12b so as to start production of an order.

A program memory 132 is connected to the controller 60, in which programs regarding an order change process and the like are fixedly stored. Further, a task memory 134 is connected to the controller 60, in which information about scheduled orders is temporarily stored.

In the sheet feeder 2, the sheet feed rollers 20 and the grate 22 are equivalent to an example of "feed-out mechanism" set forth in the appended claims, and the sheet feed roller drive motor 32 and the grate raising-lowering motor 34 are equivalent to an example of "feed-out mechanism drive motor" set forth in the appended claims.

### Order Change Process

Next, order change processes to be executed by the controller 60 of the corrugated paperboard sheet box making machine 1, according to embodiments (first to fourth embodiments) of the present invention, will be described.

### First Embodiment

In the first embodiment, the controller 60 operates, when performing the replacement work-free order change, to: after completion of production of a current order, deactivate the sheet feed rollers 20 and the grate 22 of the sheet feeder 2 so as to stop a corrugated paperboard sheet feeding operation, while enabling at least the upper slotters 27A, 28A and the lower slotters 27D, 28D to continue rotating; and after completion of set-up works, which are preparatory works for production of a next order in the sheet feeder 2, the printer 4, the creaser unit 6, the slotter unit 7, and the die cutter 8, drive the sheet feed rollers 20 and the grate 22 so as to resume the corrugated paperboard sheet feeding operation and start production of the next order. Particularly, in the first embodiment, the controller 60 operates to, during a period from the completion of production of the current order to the start of production of the next order, stop the rotation of the feed roll 24 before a sheet setting work in which an operator sets corrugated paperboard sheets in the sheet feeder 2 (such as a work of manually loading corrugated paperboard sheets onto the sheet feed table 12b (manual stacking), or a work of manually aligning corrugated paperboard sheets that have been automatically loaded into the sheet feeder by a sheet loading apparatus), and to resume the rotation of the feed roll 24 after completion of the sheet setting work. This makes it possible to ensure safety of the operator during the sheet setting work in the replacement work-free order change.

Further, in the first embodiment, the controller operates to resume the rotation of the feed roll 24, after the completion of the sheet setting work and before driving the sheet feed rollers 20 and the grate 22 to resume the sheet feeding operation. This is because the feed roll 24 has a larger moment of inertia than that of the sheet feed rollers 20 and the grate 22, and therefore it is desirable to resume the rotation of the feed roll 24 as early as possible.

Further, in the first embodiment, the controller 60 operates to, after completion of production of the current order, stop the feed roll 24 as quickly as possible. Specifically, the controller 60 operates to stop the rotation of the feed roll 24 after the completion of production of the current order and before start of order change, more specifically before the last corrugated paperboard sheet of the current order passes through the die cutter 8. By doing this, the time required for the feed roll 24 to rotationally stop no longer exerts any influence on the preparation time during the order change. Incidentally, it is theoretically known that the feed roll 24 can be stopped, for example, two seconds after start of its deceleration.

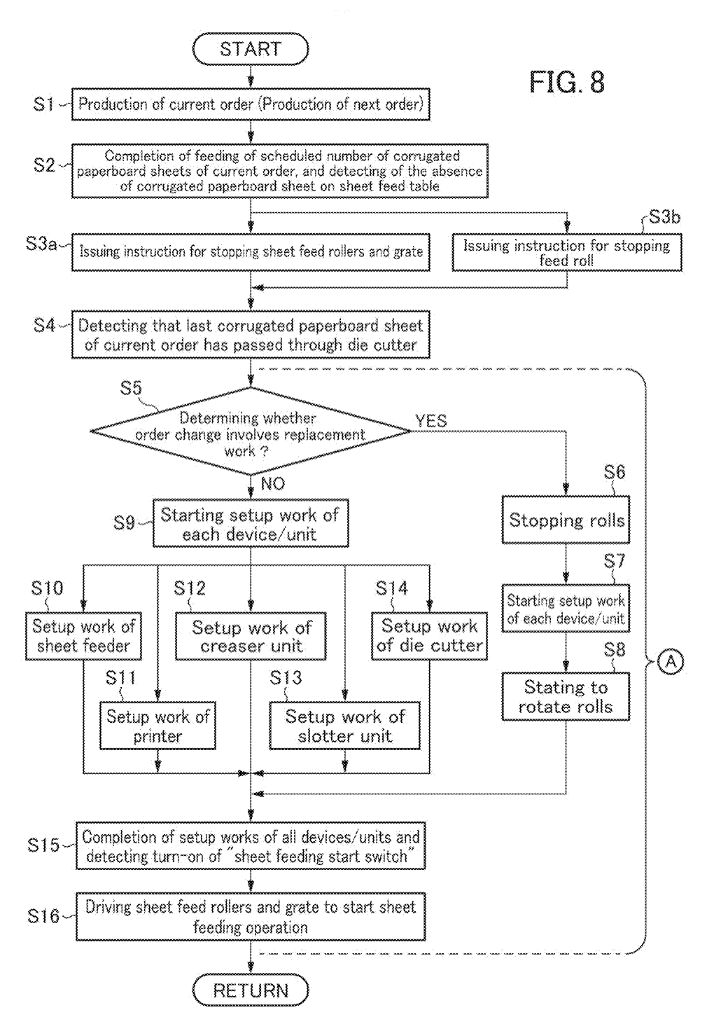

Next, with reference to FIGS. 8 to 10, an order change process to be executed by the controller 60 of the corrugated paperboard sheet box making machine 1, according to the first embodiment, will be described. Here, in FIGS. 8 to 10, each of "S," "P," and "T" indicates "step" (the same applies hereinafter).

After start, first, in S1, production of the current order is performed. Then, the process proceeds to S2, in which a program regarding an order change process is executed. Specifically, it is detected that a given number of corrugated paperboard sheets for the current order have been fed, and no corrugated paperboard sheet remains on the sheet feed table 12b. This detection is performed using a sensor (not shown).

Then, the process proceeds to S3a and S3b, in which the controller 60 issues an instruction for stopping the sheet feed rollers 20 and the grate 22 to stop the sheet feeding operation, and simultaneously issues an instruction for stopping the rotation of the feed roll 24. In this case, the controller 60 controls the sheet feed roller drive motor 32 via the sheet feed roller drive motor control unit 88 to stop the rotation of the sheet feed rollers 20, and controls the grate raising-lowering motor 34 via the grate raising-lowering motor control unit 90 to stop the operation of the grate 22. Further, the controller 60 controls the feed roll drive motor 76 via the feed roll drive motor control unit 64 to stop the rotation of the feed roll 24. It should be noted here that, since the feed roll 24 has a larger moment of inertia than that of the sheet feed rollers 20 and the grate 22, the feed roll 24 will be stopped after the stop of the sheet feed rollers 20 and the grate 22. Then, after the steps S3a and S3b, the process proceeds to S4, in which it is detected that the last corrugated paperboard sheet of the current order has passed through the die cutter 8. This detection is also performed using a sensor (not shown).

Next, the process proceeds to S5, in which it is determined whether an order change is a "replacement work-free order change." Here, as mentioned above, the "replacement work-free order change" means a case where a work of automatically positioning movable members is performed in each device/unit of the box making machine, and a work in which an operator sets corrugated paperboard sheets to be processed in a next order, on the sheet feed table 12b (sheet setting work) is performed in the sheet feeder 2. On the other hand, the "replacement work-involved order change" means a case where a replacement work for the printing plate of the printer 4, and/or a replacement work for the cutting die of the die cutter 8 are performed, in addition to the works performed in the "replacement work-free order change."

When it is determined, in S5, that the intended order change is the "replacement work-involved order change," the process proceeds to S6. First, in S6, each device/unit relevant to the determination (the feed roll 24, the printer 4, the creaser unit 6, the slotter unit 7, and the die cutter 8) is stopped. Then, the process proceeds to S7, in which the setup works of the devices/units are started. During the setup works, replacement of the printing plate and replacement of the cutting die of the die cutter 8 are performed. Then, the process proceeds to S8, in which the rolls of the devices/units are rotated. Subsequently, the process proceeds to the after-mentioned S15 and S16.

Next, when it is determined, in S5, that the intended order change is not the "replacement work-involved order change," i.e., is the "replacement work-free order change," the process proceeds to S9, in which the setup work of each device/unit are started. In this process, the setup works of the devices/units are performed in a simultaneous parallel manner. That is, the setup works in the below-mentioned S10, S11, S12, S13, and S14 are performed in a simultaneous parallel manner.

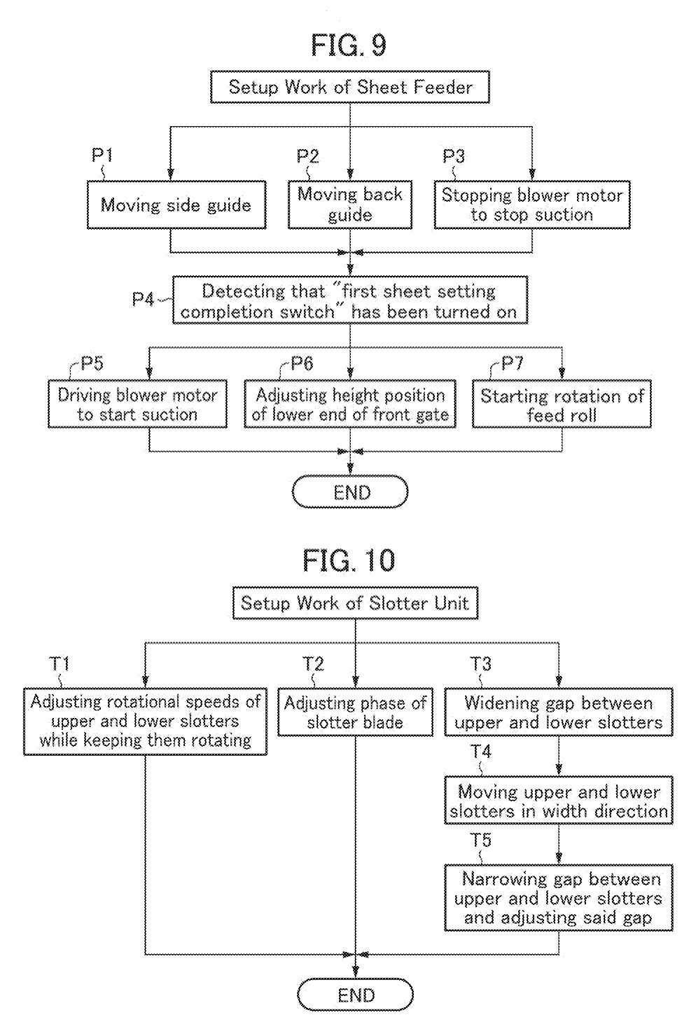

First, the process proceeds to S10, in which the setup work of the sheet feeder 2 is performed. The details of the setup work of the sheet feeder 2 will be described with reference to FIG. 9. In P1, the side guide 17 are moved to a position according to the dimension of the corrugated paperboard sheets of the next order in the width direction. Further, in P2, parallel with P1, the back guide 16 is moved to a position according to the dimension of the corrugated paperboard sheets of the next order in the feed-out direction. Further, in P3, parallel with P1 and P2, rotation of the blower motor 94 is stopped to stop the suction. After the sub-works in P1, P2, and P3, a sheet setting work is performed by an operator.

Then, the process proceeds to P4, in which it is detected that the first sheet setting completion switch 128 of the operation panel has been operated. Subsequently, the process proceeds to P5 and P6. In P5, the blower motor 94 is rotated to start the suction, and in P6, parallel with P5, the height position of the lower end of the front gate 14 is adjusted such that only one corrugated paperboard sheet of the next order can pass through the gap between the lower end of the front gate 14 and the upper surface of the sheet feed table 12b. Further, in P7, parallel with P5 and P6, the rotation of the feed roll 24 is started (resumed).

Then, returning to step S11 in FIG. 8, the setup work of the printer 4 is performed. For example, in a case where a first color is used in the current order and a second color is used in the next order, the setup work comprises:
1) adjusting the rotational speeds of the first-color and second-color press rolls 25D, 26D such that they have a circumferential speed according to the production speed of the next order, while keeping them rotating;
2) stopping the rotation of the printing cylinder 25A of the first-color printing unit 25;
3) moving the first-color printing unit 25 from the lower use position to the upper standby position;
4) while rotating the printing cylinder 26A of the second-color printing unit 25, adjusting the printing cylinder 26A in terms of rotational speed to have a circumferential speed according to the production speed of the next order; and
5) moving the second-color printing unit 26 from the upper standby position to the lower use position.

The above sub-works 1) to 5) are performed in a simultaneous parallel manner. However, among the sub-works 1) to 5), the sub-works 2) and 3) do not necessarily have to be performed in a simultaneous parallel manner. For example, after completion of the sub-work 2), i.e., after the rotation of the printing cylinder 25A of the first-color printing unit 25 is stopped, the sub-work 3) may be performed, i.e., the first-color printing unit 25 may be moved from the lower use position to the upper standby position. Further, among the sub-works 1) to 5), the sub-works 4) and 5) do not necessarily have to be performed in a simultaneous parallel manner. For example, after completion of the sub-work 5), i.e., after the second-color printing unit 26 is moved from the upper standby position to the lower use position, the sub-work 4) may be performed in which the printing cylinder 26A of the second-color printing unit 26, which has been in a rotation-stopped state, is activated to rotate, and adjusted in terms of rotational speed to have a circumferential speed according to the production speed of the next order.

Then, the process proceeds to step S12 in FIG. 8, in which the setup work of the creaser unit 6 is performed, wherein the setup work comprises: 1) while keeping rotating the upper and lower creasing rolls 6A, 6B, adjusting the rotational speeds of the creasing rolls 6A, 6B such that the creasing rolls 6A, 6B have respective circumferential speeds according to the production speed of the next order; 2) adjusting the gap between the upper and lower creasing rolls 6A, 6B to a value according to the thickness of the corrugated paperboard sheets of the next order; and 3) moving a width-directional position of the upper and lower creasing rolls 6A, 6B to a creasing position of the corrugated paperboard sheets of the next order. These sub-works 1) to 3) are performed in a simultaneous parallel manner.

Then, the process proceeds to S13 in FIG. 8, in which the setup work of the slotter unit 7 is performed. The details of the setup work of the slotter unit 7 will be described with reference to FIG. 10. In T1, the rotational speeds of the upper and lower slotters 27A, 27D (28A, 28D) are adjusted such that the slotters 27A, 27D (28A, 28D) have respective circumferential speeds according to the production speed of the next order, while the slotters 27A, 27D (28A, 28D) are kept rotating. In T2, the phase of the slotter blade 27B (28B) of the upper slotter 27A (28A) is adjusted in accordance with a slotting dimension of the corrugated paperboard sheets of the next order. In T3, a gap between the upper and lower slotters 27A, 27D (28A, 28D) is widened such that the slotter blade 27B (28B) of the upper slotter 27A (28A) do not fit with the groove 27C (28C) of the lower slotter 27D (28D). These sub-works T1, T2, and T3 are performed in a simultaneous parallel manner.

Then, in T4, the width-direction position of the upper and lower slotters 27A, 27D (28A, 28D) is moved to the slotting position of the corrugated paperboard sheet of the next order. Here, after T3 is performed, T4 is performed simultaneously or in parallel with T1 and T2.

Then, in T5, the gap between the upper and lower slotters 27A, 27D (28A, 28D) is narrowed such that the slotter blade 27B (28B) of the upper slotter 27A (28A) is fitted into the groove 27C (28C) of the lower slotter 27D (28D), and the gap is adjusted to a value according to the thickness of the corrugated paperboard sheets of the next order. Here, after T4 is performed, T5 is performed simultaneously or in parallel with T1 and T2.

Then, the process proceeds to S14 in FIG. 8, in which the setup work of the die cutter 8 is performed, wherein the setup work comprise: 1) while keeping rotating the die cylinder 30 and the anvil cylinder 29, adjusting the rotational speeds of the die cylinder 30 and the anvil cylinder 29 such that each of the die cylinder 30 and the anvil cylinder 29 has a circumferential speed according to the production speed of the next order; and 2) adjusting a gap between the die cylinder 30 and the anvil cylinder 29 to a value according to the thickness of the corrugated paperboard sheets of the next order. Here, the sub-works 1) and 2) are performed in a simultaneous parallel manner.

Then, the process proceeds to S15, in which it is detected that the setup works of all the devices/units have been completed and the "sheet feeding start switch" of the operation panel has been operated. Then, the process proceeds to S16, in which the sheet feed rollers 20 and the grate 22 are driven to start the sheet feeding operation, thereby starting production of the next order.

In an actual order change, after completion of the setup works, only one corrugated paperboard sheet is fed to perform trial processing and inspection, and then continuous sheet feeding is performed to start production of the next order. However, a description thereof is omitted here.

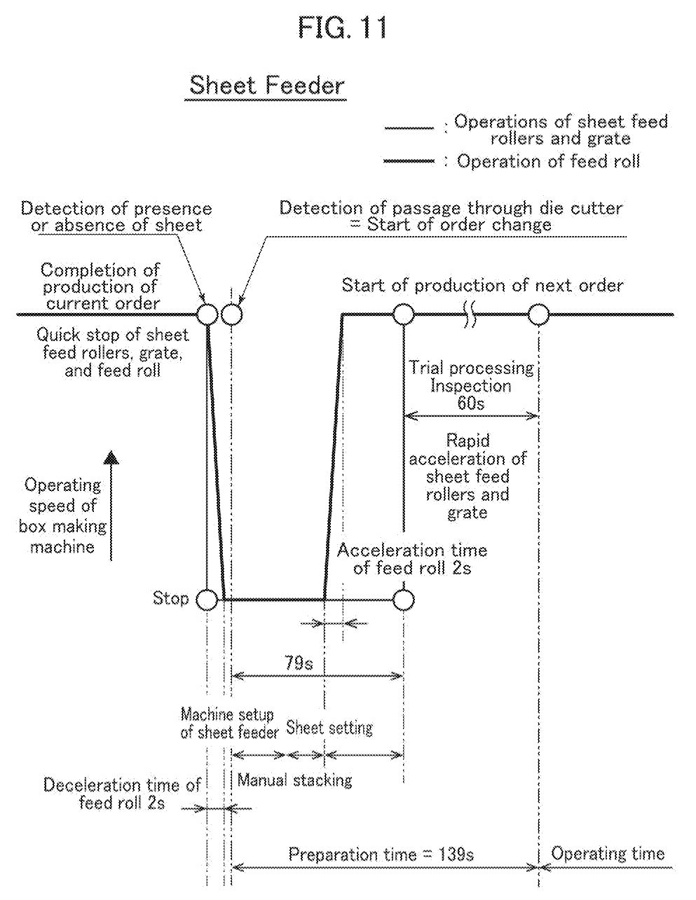

Next, with reference to FIG. 11, functions/effects obtainable by the corrugated paperboard box making machine 1 according to the first embodiment will be described. FIG. 11 is a time chart showing the time for the setup work of the sheet feeder 2 of the corrugated paperboard box making machine 1 according to the first embodiment, during an order change.

As shown in FIG. 11, in the first embodiment, in the replacement work-free order change, at the time of completion of production of the current order (this time corresponds to a timing when it is detected that no corrugated paperboard sheet remains on the sheet feed table 12b), the sheet feed rollers 20 and the grate 22 are stopped, and the rotation of the feed roll 24 is also stopped. In this case, since the sheet feed rollers 20 and the grate 22 have relatively small moments of inertia, they are stopped promptly, whereas the feed roll 24 has a relatively large moment of inertia and is therefore stopped after a deceleration time, for example, of two seconds. In the first embodiment, the feed roll 24 is controlled to be stopped as quickly as possible. Thus, before an order change is started after the completion of production of the current order, i.e., before the last corrugated paperboard sheet of the current order passes through the die cutter 8, the feed roll 24 is stopped.

Then, after the start of the order change, i.e., after the last corrugated paperboard sheet of the current order has passed through the die cutter 8, machine setup of the sheet feeder 2 is first performed. Specifically, the back guide 16 and the side guide 17 are moved, and the blower motor 94 is stopped. Subsequently, a sheet setting work of manually setting corrugated paperboard sheets of the next order on the sheet feed table 12b, specifically, a work of loading corrugated paperboard sheets on the sheet feed table 12b (manual stacking), is performed by an operator. After completion of this sheet setting work (specifically, after operation of the first-sheet setting completion switch 128), the rotation of the feed roll 24 is started (resumed). Further, the height position of the lower end of the front gate 14 is adjusted, and the blower motor 94 is driven. In this case, the feed roll 24 also promptly resume its rotation (the acceleration time is, for example, 2 seconds).

As just described, when the setup work is being performed in the sheet feeder 2, the setup works of other devices/units of the box making machine 1 are simultaneously performed. The time required for the setup work of each device/unit is, for example, 79 seconds. When all the setup works of the devices/units of the box making machine 1 are completed in this manner, the sheet feed rollers 20 and the grate 22 are driven to start production of the next order. In this case, first, trial processing and inspection for production of the next order are performed (for example, 60 seconds). Thus, according to the first embodiment, the total preparation time for an order change is, e.g., 139 seconds.

According to the first embodiment described above, in the replacement work-free order change, during the period from the completion of production of the current order to start of production of the next order, the rotation of the feed roll 24 is stopped before the sheet setting work in which an operator sets corrugated paperboard sheets in the sheet feeder 2, and then the rotation of the feed roll 24 is resumed after the completion of the sheet setting work. Thus, since the feed roll 24 is in the rotation-stopped state when the operator starts performing the sheet setting work, safety of the operator during the sheet setting work can be ensured. Specifically, even if the operator's finger inadvertently enters the gap SP of the sheet feeder 2 during the sheet setting work, it is possible to reliably prevent injury to the operator's finger.

Further, according to the first embodiment, after completion of production of the current order, the rotation of the feed roll 24 is stopped promptly. Thus, since the feed roll 24 is in the rotation-stopped state before start of the order change, i.e., the feed roll has already been stopped at the time of the order change in which the setup works are performed, it is not necessary to confirm that the rotation of the feed roll is in the rotation-stopped state, in order to guarantee safety of the operator during the sheet setting work.

In the above description, a condition that the last corrugated paperboard sheet of the current order has passed through the die cutter 8 is used as a condition for starting an order change, and the fact that the corrugated paperboard sheet has passed through the die cutter 8 is detected by a sensor. In another example, an order change may be started by counting a time until the last corrugated paperboard sheet passes through the die cutter 8, instead of using such a sensor. Specifically, first, a time obtained by dividing a distance from the sheet feeder 2 to the die cutter 8 by the production speed of the box making machine 1 (sheet arrival time) is calculated preliminarily. Then, a time counting device is provided in the controller 60, wherein the time counting device starts counting time at a timing when the last corrugated paperboard sheet of the current order has been fed out from the sheet feeder 2 (this timing may be detected, for example, by a sensor), whereafter the controller 60 starts the order change at a timing when the counted time has coincided with the sheet arrival time preliminarily calculated.

### Second Embodiment

Next, a second embodiment of the present invention will be described. It should be noted that descriptions of similar or the same elements or components to/as those of the first embodiment will be omitted here. That is, any elements or components not particularly described here shall be similar to or the same as those of the first embodiment. (The second embodiment may be appropriately combined with the first embodiment.)

In the first embodiment described above, the feed roll 24 is stopped as quickly as possible after the completion of production of the current order (for example, with a deceleration time of 2 seconds). However, as the deceleration time becomes shorter, a larger load is applied to the feed roll 24 and surrounding components associated therewith, leading to premature failure of machine components. Therefore, first, in the second embodiment, with a view to reducing such a large load, the controller 60 operates to stop the feed roll 24 relatively slowly. For example, the controller 60 operates to stop the feed roll 24 with a deceleration time of 7 seconds.

Further, in the second embodiment, the controller 60 is configured to determine whether or not the rotation of the feed roll 24 has been stopped, and to permit performing the setup work of each device/unit after determining that the rotation of the feed roll 24 has been stopped. That is, the controller 60 performs control for creates a situation wherein the start of an order change is not permitted and thus the setup work of the sheet feeder 2 cannot be performed, until the rotation of the feed roll 24 is stopped.

The above control will now be specifically described in detail. First, in setting of corrugated paperboard sheets on the sheet feeder 2, it is necessary to place the corrugated paperboard sheets on the sheet feed table 12b in accordance with the positions of the back guide 16 and the side guide 17 according to the next order. Thus, if the positioning (movement) of the back guide 16 and the side guide 17 according to the next order has not been completed, the sheet setting work in the sheet feeder 2 cannot be performed. Therefore, in the second embodiment, in order to create a situation wherein the setup work of the sheet feeder 2 cannot be performed so as not to permit the start of an order change, until the rotation of the feed roll 24 is stopped, the controller 60 operates to prevent the movements of the back guide 16 and the side guide 17 from being started, until the rotation of the feed roll 24 is stopped. That is, the controller 60 is configured to start the movements of the back guide 16 and the side guide 17 after determining that the rotation of the feed roll 24 has been stopped.

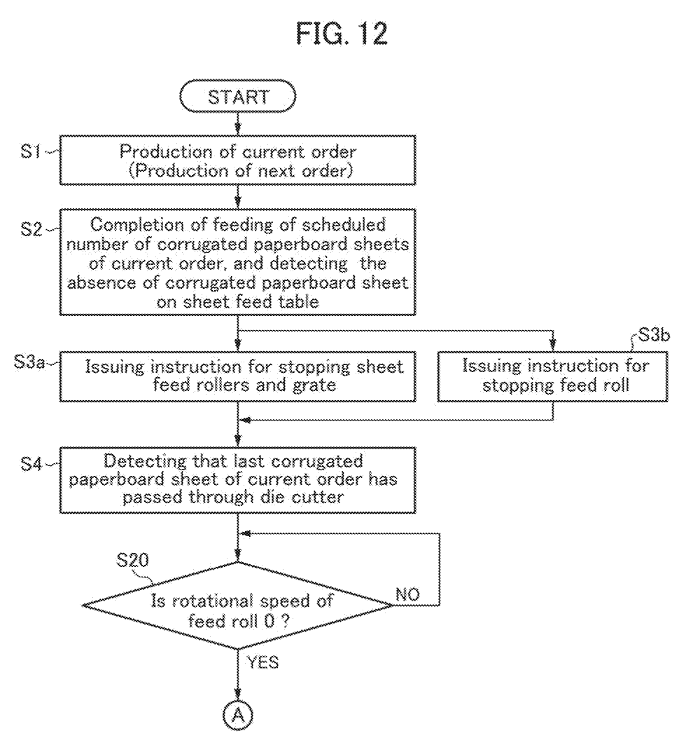

Next, with reference to FIG. 12, a flowchart showing an order change process according to the second embodiment will be described. The order change process according to the second embodiment is different from that of the first embodiment in that a determination in S20 is performed between the detection of passage of the last corrugated paperboard sheet of the current order through the die cutter 8 (S4) and the determination as to whether the intended order change is the replacement work-involved order change (S5) (see FIG. 8). S1 to S4, and S5 to S16 (which are indicated by reference sign A in FIGS. 8 and 12), are the same as those in the first embodiment.

In the second embodiment, in S20, the controller 60 determines whether the rotational speed of the feed roll 24 (feed roll rotational speed) is 0 (zero), that is, i.e. the rotation of the feed roll 24 has been stopped. In one example, the controller 60 performs this determination by obtaining the feed roll rotational speed based on a signal from an encoder provided in the feed roll drive motor 76. When the controller 60 determines that the feed roll rotational speed is 0, i.e. when the rotation of the feed roll 24 has been stopped, the process proceeds to S5. On the other hand, when the controller 60 does not determine that the feed roll rotational speed is 0, i.e. when the rotation of the feed roll 24 has not yet been stopped, the process returns to S20. The controller 60 repeatedly performs the determination in S20 until it determines that the feed roll rotational speed is 0, to prevents performing the order change operation.

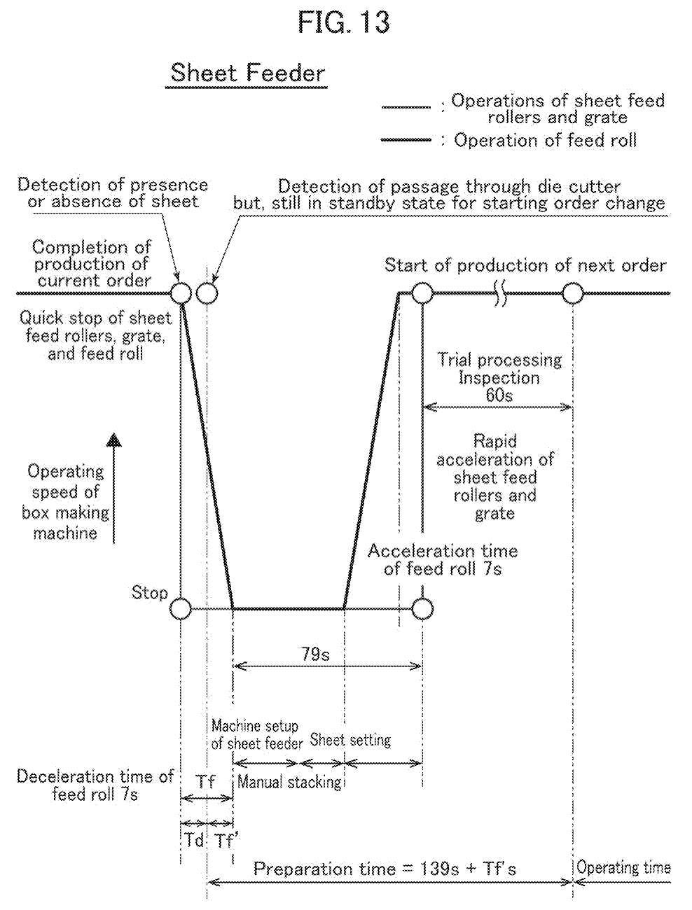

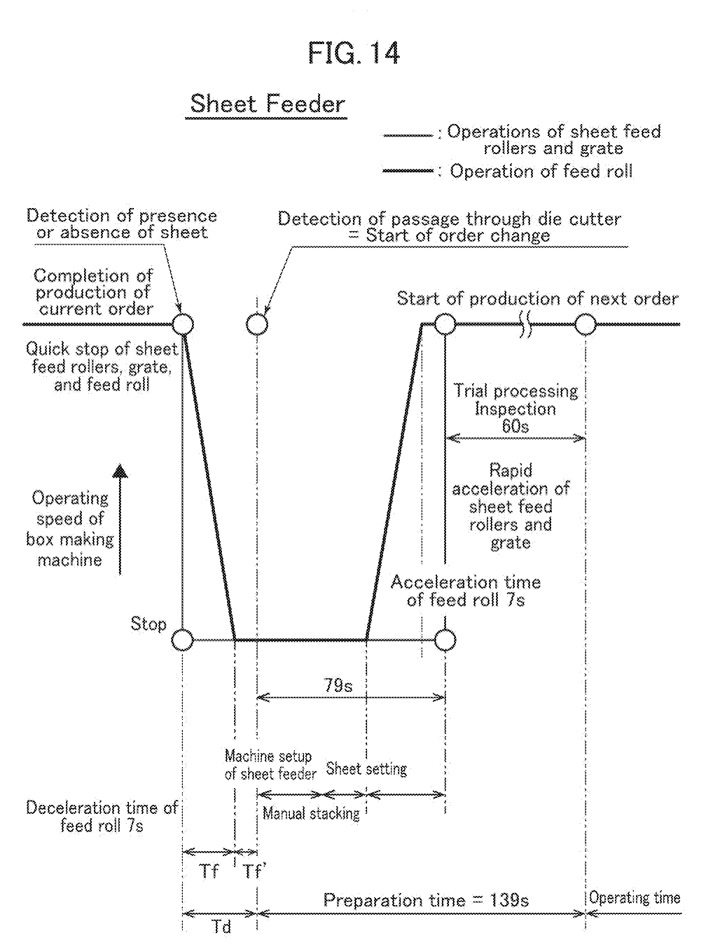

Next, FIGS. 13 and 14 are time charts showing two examples of a setup work of the sheet feeder 2 during an order change according to the second embodiment. As shown in FIG. 13, in the second embodiment, the feed roll 24 is stopped more slowly than in the first embodiment (for example, with a deceleration time of 7 seconds). In the example illustrated in FIG. 13, after the completion of production of the current order (which corresponds to a timing when it is detected that no corrugated paperboard sheets remain on the sheet feed table 12b), the feed roll 24 is stopped after the last corrugated paperboard sheet of the current order has passed through the die cutter 8. Assuming that a time from a time point when production of the current order is completed to a time point when the feed roll 24 is stopped is defined as "Tf," and a time from a time point when production of the current order is completed to a time point when the last corrugated paperboard sheet of the current order passes through the die cutter 8 is defined as "Td", "Tf > Td" is satisfied, and the difference between the two times is "Tf' = Tf - Td." In the example illustrated in FIG. 13, the order change is started at the timing when the feed roll 24 is stopped, instead of the timing when the last corrugated paperboard sheet of the current order passes through the die cutter 8. Operations after the start of the order change are the same as those in the first embodiment (FIG. 11). For example, in the example illustrated in FIG. 13, the total preparation time for the order change is a time (139 + Tf') obtained by adding the temporal difference Tf' to 139 seconds in the first embodiment.

Next, in the example illustrated in FIG. 14, as in the first embodiment, the feed roll 24 is stopped before the last corrugated paperboard sheet of the current order passes through the die cutter 8. Thus, "Tf < Td" is satisfied. In this example, the order change is started at the timing when the last corrugated paperboard sheet of the current order passes through the die cutter 8, instead of the timing when the feed roll 24 is stopped. For example, in the example illustrated in FIG. 14, the total preparation time for the order change is 139 seconds, which is the same as in the first embodiment.

According to the second embodiment described above, performing the setup work of each device/unit is permitted after it is determined that the rotation of the feed roll 24 has been stopped. Thus, it becomes possible to effectively ensure safety of the operator during the sheet setting work. In addition, according to the second embodiment, the feed roll 24 is stopped more slowly than in the first embodiment. Thus, it becomes possible to reduce the load applied to the feed roll 24 and surrounding components associated therewith.

In the above description, the determination as to whether or not the rotation of the feed roll 24 has been stopped is made based on the feed roll rotational speed. However, the present invention is not limited to determining the stop of the rotation of the feed roll 24 based on the rotational speed. In another example, the determination as to whether or not the rotation of the feed roll 24 has been stopped may be made based on a torque value of the feed roll 24, or a drive current/voltage of the feed roll 24. In another example, the determination as to whether or not the rotation of the feed roll 24 has been stopped may be made based on an elapsed time from issuance of a stop instruction for the feed roll 24. For example, if a time from a time point when the stop instruction for the feed roll 24 is issued to a time point when the feed roll 24 is stopped has been experimentally obtained for each production speed of the box making machine 1, it is possible to count a feed roll rotation stopping time of the feed roll 24 under a production speed of the present order, from a timing when the last corrugated paperboard sheet is detected by a detection sensor (which corresponds to an ending time of production of the current order or a timing when the stop instruction for the feed roll 24 is issued), so as to determine that the rotation of the feed roll 24 has been stopped.

### Third Embodiment

Next, a third embodiment of the present invention will be described. It should be noted that descriptions of similar or the same elements or components to/as those of the first and second embodiments will be omitted here. That is, any elements or components not particularly described here shall be similar to or the same as those of the first and second embodiments. (The third embodiment may be appropriately combined with the first and second embodiments.)

In order to effectively ensure safety of operator during the sheet setting work, the second embodiment described above is configured such that the start of an order change is not permitted until it is determined that the rotation of the feed roll 24 has been stopped. Specifically, it is configured such that operations such as positionings (movements) of the side guide 17 and the back guide 16 are not started until it is determined that the rotation of the feed roll 24 has been stopped.

Differently from the second embodiment, in the third embodiment, the controller 60 operates to start positionings (movements) of the side guide 17 and the back guide 16 within a period during which the rotation of the feed roll 24 is decelerated and finally stopped. In this case, the controller 60 operates to prevent the movements of the side guide 17 and the back guide 16 from being completed before the rotation of the feed roll 24 is stopped, i.e., to complete the movements of the side guide 17 and the back guide 16 at the time of or after the stop of the feed roll 24. This makes it possible to ensure safety of the operator during the sheet setting work, because the feed roll 24 is in the rotation-stopped state when the movements of the side guide 17 and the back guide 16 have been completed (at this time, the sheet feeder 2 is placed in a state in which the sheet setting work can be performed).

Specifically, the controller 60 compares: a time Tf' (Tf' = Tf - Td) obtained by subtracting a time Td from a time point when the last corrugated paperboard sheet of the current order is fed out from the sheet feeder 2 to a time point when said last corrugated paperboard sheet passes through the die cutter 8, from a time Tf from a time point when the feed roll 24 starts being decelerated to a time point when it is stopped, with a side guide movement time Ts and a back guide movement time Tb, each of which is a time between the start and the end of positioning (movement) of a corresponding one of the side guide 17 and the back guide 16, wherein when Tf' > Ts or Tb, the controller 60 operates to change the movement speeds of the side guide 17 and/or the back guide 16 such that the movement speeds are lowered. Here, it is assumed that the movements of the side guide 17 and the back guide 16 are started at a timing when the last corrugated paperboard sheet of the current order passes through the die cutter 8.

Preferably, the controller 60 operates to set the respective moving speeds of the side guide 17 and the back guide 16 such that the movements of the side guide 17 and the back guide 16 are completed at the timing when the rotation of the feed roll 24 is stopped, i.e., such that a timing when the rotation of the feed roll 24 is stopped coincides with a timing when the movements of the side guide 17 and the back guide 16 are completed.

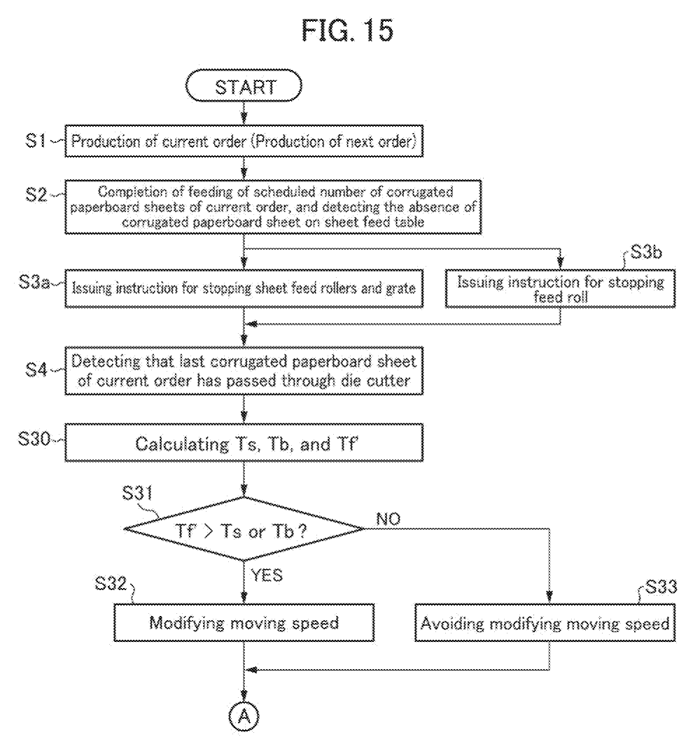

Next, with reference to FIG. 15, a flowchart illustrating an order change process according to a third embodiment will be described. The order change process according to the third embodiment is different from that of the first embodiment (FIG. 8) in that S30 to S33 are performed between the detection of passage of the last corrugated paperboard sheet of the current order through the die cutter 8 (S4) and the determination as to whether or not the intended order change is the replacement work-involved order change (S5). S1 to S4 and S5 to S16 (indicated by reference sign A in FIGS. 8 and 15) are the same as those in the first embodiment.

In the third embodiment, the controller 60 is configured to, prior to S30 (for example, just after S1), acquire, from a production management apparatus, information about a displacement amount ΔX of the side guide 17 and a displacement amount ΔY of the back guide 16 each calculated from order information of the current and next orders, and further acquire the moving speed Vs of the side guide 17, the moving speed Vb of the back guide 16, and a time Tf (for example, 7 seconds) from a time point when the feed roll 24 starts being decelerated to a time point when it is stopped, which are preliminarily set and stored.

In the third embodiment, in S30, the controller 60 calculates a side guide movement time Ts (= ΔX / Vs) and a back guide movement time Tb (= ΔY / Vb) during the order change. These times may be calculated at a timing just before each order is changed, or at a timing when an operator inputs a production schedule for corrugated paperboard boxes to be produced in one day by the box-making machine 1, to the product management apparatus, after turning on power of the box making machine 1. Further, in S30, the controller 60 calculates a time Td from a time point when the last corrugated paperboard sheet of the current order is fed out from the sheet feeder 2 to a time point when said corrugated paperboard sheet passes through the die cutter 8 (for example, the time Td is calculated by a time counting device provided in the controller 60), and calculates a time Tf' by subtracting this time Td from a time Tf from a time point when the feed roll 24 starts being decelerated to a time point when it is stopped (Tf' = Tf - Td).

Then, in S31, the controller 60 determines whether the time Tf' is greater than the side-guide movement time Ts or the back-guide movement time Tb. As a result, when the controller 60 determines that the time Tf' is greater than the side-guide movement time Ts or the back-guide movement time Tb (Tf' > Ts, Tb), the process proceeds to S32. In this case, the movements of the side guide 17 and the back guide 16 will be completed before the rotation of the feed roll 24 is stopped. In other words, even after the movement of the side guide 17 or the back guide 16 is completed, the rotation of the feed roll 24 continues (i.e., the feed roll 24 continues being decelerated). Thus, in S32, the controller 60 modifies the moving speed Vs of the side guide 17 and/or the moving speed Vb of the back guide 16 to a lower speed such that the movements of the side guide 17 and the back guide 16 are not completed before the rotation of the feed roll 24 is stopped.

Here, a case where the time Tf' is greater than the movement time Ts of the side-guide (Tf' > Ts) will be assumed. In this case, the controller 60 modifies the moving speed Vs of the side guide 17 such that a timing when the rotation of the feed roll 24 is stopped coincides with a timing when the movement of the side guide 17 is completed.

Specifically, assuming that a modified moving speed of the side guide 17 is denoted as Vs', the controller 60 calculates Vs' by the formula "Vs' =ΔX / Tf'," so as to allow Vs' to be adjusted to a speed according to Tf'. Similarly, in a case where the time Tf' is greater than the movement time Tb of the back-guide (Tf' > Tb), the controller 60 calculates a modified moving speed Vb' of the back guide 16 by the formula "Vb' =ΔY / Tf'," such that a timing when the rotation of the feed roll 24 is stopped coincides with a timing when the movement of the back guide 16 is completed.

On the other hand, in S31, when the controller 60 does not determine that the time Tf' is greater than the movement time Ts of the side guide and the movement time Tb of the back guide, i.e., when the time Tf' is equal to or less than the movement time Ts of the side guide and the movement time Tb of the back guide (Tf' ≤ Ts and Tb), the process proceeds to S33. In this case, a successive operation of the feed roll 24 during a period from a time point when the feed roll 24 starts being decelerated through until it is stopped is completed before the movements of the side guide 17 and the back guide 16 are completed. Thus, the controller 60 avoids modifying the moving speed Vs of the side guide 17 or the moving speed Vb of the back guide 16 (S33). That is, the controller 60 uses the original moving speed Vs and the original moving speed Vb as-is.

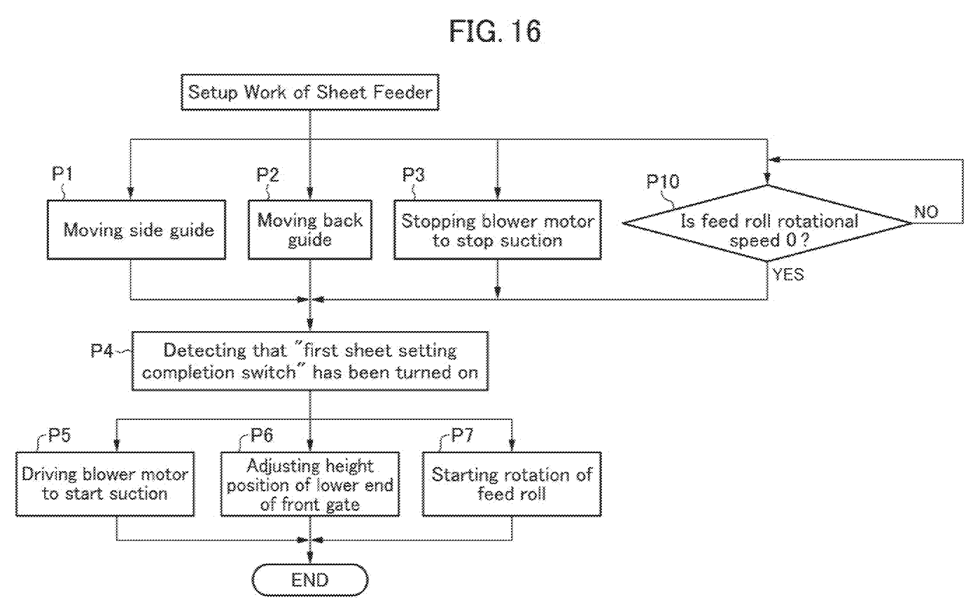

Next, with reference to FIG. 16, a flowchart showing the setup work of the sheet feeder 2 according to the third embodiment will be described. In the setup work of the sheet feeder 2 according to the third embodiment, the controller 60 determines, in P10, whether or not the feed roll rotational speed is 0 (zero), i.e., determines whether or not the rotation of the feed roll 24 has been stopped, in parallel with the movement of the side guide 17 (P1), the movement of the back guide 16 (P2), and the stopping of the blower motor 94 (P3). This determination method is the same as that in the second embodiment. By using the moving speeds of the side guide 17 and the back guide 16 set in the above manner, the movements of the side guide 17 and the back guide 16 will be completed at the time of or after the stop of the rotation of the feed roll 24. Thus, since the feed roll 24 is in the rotation-stopped state when the movements of the side guide 17 and the back guide 16 have been completed, i.e., when an operator starts the sheet-setting work, safety of the sheet-setting work will be ensured.

According to the third embodiment described above, the side guide 17 and the back guide 16 are moved during a period from a time point when the rotation of the feed roll 24 is decelerated through until it is stopped (i.e., before the start of an order change). Thus, it becomes possible to reduce the setup work (machine setup) of the sheet feeder 2 during the order change, and shorten the preparation time for the order change.

In addition, according to the third embodiment, the moving speeds of the side guide 17 and the back guide 16 are controlled such that the movements of the side guide 17 and the back guide 16 are completed at a timing when the rotation of the feed roll 24 is stopped. In this case, since the feed roll 24 is in the rotation-stopped state when the movements of the side guide 17 and the back guide 16 have been completed, i.e., when an operator starts the sheet-setting work, it becomes possible to ensure safety of the sheet-setting work. Further, since the movements of the side guide 17 and the back guide 16 are completed when the rotation of the feed roll 24 is stopped (this timing corresponds to the start of the order change), it becomes possible to further shorten the preparation time during the order change.

As described above, both the side guide movement time Ts and the back guide movement time Tb are calculated. Alternatively, only a longer one of these two movement times may be adopted and sharingly used to determine the moving speeds of the side guide 17 and the back guide 16. By doing so, positionings of the side guide 17 and the back guide 16 are completed at the same timing. Thus, an operator can determine a timing when corrugated paperboard sheets start being set in the sheet feeder 2 by confirming that the positioning of only one of them has been completed.

### Fourth Embodiment

Next, a fourth embodiment of the present invention will be described. It should be noted that descriptions of similar or the same elements or components to/as those of the first to third embodiments will be omitted here. That is, any elements or components not particularly described here shall be similar to or the same as those of the first to third embodiments. (the fourth embodiment can be appropriately combined with the first to third embodiments).

Although the fourth embodiment is configured to stop the rotation of the feed roll 24 after the completion of production of the current order, as in the first to third embodiments, it is further configured to notify that the feed roll 24 is undergoing decelerating rotation and that the rotation of the feed roll 24 has been stopped. Such notification is performed because, due to the presence of the feed roll cover 24a (FIGS. 18A and 18B), it is difficult to figure out a rotational state of the feed roll 24 by observing the feed roll 24 from the outside.

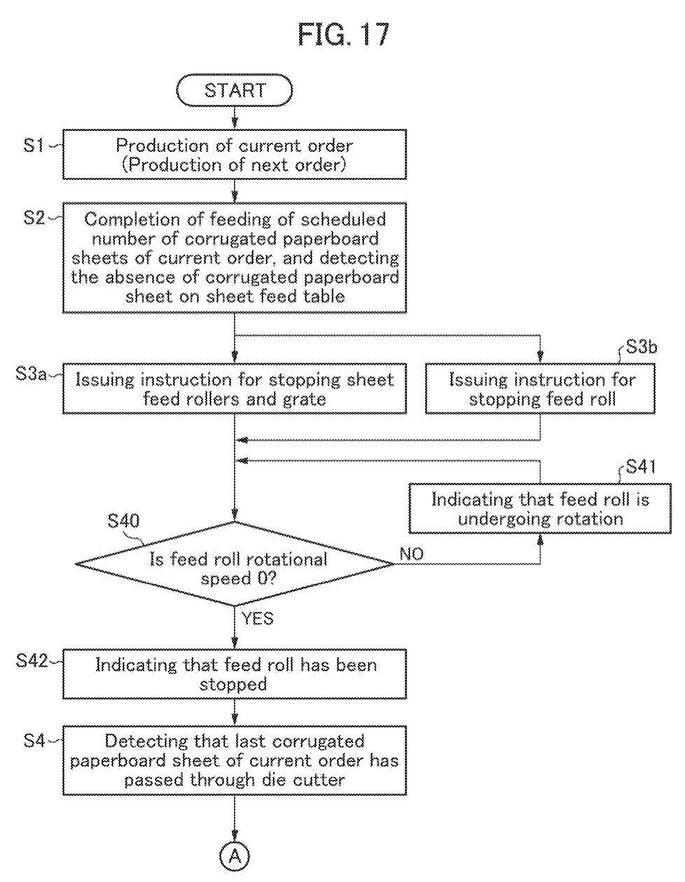

Next, with reference to FIG. 17, a flowchart showing an order change process according to the fourth embodiment will be described. The order change process according to the fourth embodiment is different from that of the first embodiment in that S40 to S42 are performed between the issuance of stop instructions to the sheet feed rollers 20, the grate 22, and the feed roll 24 (S3a, S3b) and the detection of passage of the last corrugated paperboard sheet of the current order through the die cutter 8 (S4) (FIG. 8). S1 to S3a, S3b, S4, and S5 to S16 (indicated by reference sign A in FIGS. 8 and 17), are the same as those in the first embodiment.

In the fourth embodiment, in S40, the controller 60 determines whether or not the feed roll rotational speed is 0 (zero), i.e., determines whether the rotation of the feed roll 24 has been stopped. This determination method is the same as that in the second embodiment. When the controller 60 determines that the feed roll rotational speed is 0, i.e., when the feed roll 24 is in the rotation-stopped state, the process proceeds to S42, in which the controller 60 operated to cause an operation panel 126, which serves as a notification device, to indicate that the rotation of the feed roll 24 has been stopped. On the other hand, when the controller 60 does not determine that the feed roll rotational speed is 0, i.e., when the rotation of the feed roll 24 has not yet been stopped, the process proceeds to S41, in which the controller 60 operates to cause the operation panel 126 to indicate that the feed roll 24 is undergoing the decelerating rotation.

According to the fourth embodiment as described above, it is possible to notify an operator of a fact that the feed roll 24 is undergoing decelerating rotation, and a fact that the rotation of the feed roll 24 has been stopped, i.e., of the rotational state of the feed roll 24. Thus, the operator can easily determine whether or not the sheet feeder 2 is placed in a state in which corrugated paperboard sheets can be set therein.

In the above embodiment, the operation panel 126 is used to notify the fact that the feed roll 24 is undergoing the decelerating rotation or the fact that the rotation of the feed roll 24 has been stopped. Alternatively, in another example, such notification may be performed by using a rotating warning light provided in the sheet feeder 2 to indicate an operating state of the sheet feeder 2. In this case, colors or lighting patterns indicating the state of decelerating rotation and the rotation stop of the feed roll 24 may be preliminarily determined in the rotating warning light. In still another example, instead of performing visual notification as described above, the state of decelerating rotation and the rotation stop of the feed roll 24 may be auditorily notified by siren or announcement using a speaker or the like provided in the sheet feeder 2. According to such auditory notification, an operator can easily determine whether or not the sheet feeder 2 is placed in a state in which corrugated paperboard sheets can be set therein without making the effort to check the operation panel 126 or the rotating warning light.

### Modifications

Next, some modifications of the above-mentioned embodiments will be described.

### Modification 1

The above embodiments show examples where the present invention is applied to the sheet feeder 2 comprising the sheet feed rollers 20, and the grate 22, i.e. the sheet feeder 2 configured as a so-called lead edge feeder type. In another example, the present invention may also be applied to a sheet feeder comprising a kicker device for pushing a corrugated paperboard sheet toward the feed roll 24, instead of the sheet feed rollers 20 and the grate 22, i.e., a sheet feeder configured as a so-called kicker type (see, for example, Reference 1). In this case, the kicker device is equivalent to one example of "feed-out mechanism" set forth in the appended claims, and a motor for driving the kicker device is equivalent to one example of a "feed-out mechanism drive motor" set forth in the appended claims. Since such a kicker-type sheet feeder also comprises a side guide and a back guide, the above first to fourth embodiments can be applied thereto.

In still another example, since the lead edge feeder-type sheet feeder also include a type that does not comprise a grate, the present invention can also be applied to such a lead edge feeder-type sheet feeder equipped with no grate (see, for example, Reference 1). In this case, sheet feed rollers are equivalent to one example of "feed-out mechanism" set forth in the appended claims, and a sheet feed roller drive motor is equivalent to one example of (feed-out mechanism drive motor" set forth in the appended claims. Since this lead edge feeder-type sheet feeder is equipped with no grate, the control associated with the grate described in the first to fourth embodiments may be omitted.

### Modification 2

In the above embodiments, it is described that, in the replacement work-free order change, the printer 4, the creaser unit 6, the slotter unit 7, and the die cutter 8 are maintained in an operating state (see, for example, FIG. 8). In the replacement work-free order change, the folder gluer 9 located downstream of the die cutter 8 may also be maintained in an operating state. Specifically, in the folder gluer 9, a conveyance belt for conveying corrugated paperboard sheets, a panel folding belt that contacts a panel of the corrugated paperboard sheet to be folded, and the like (see, for example, JP6995331B2) may be maintained in an operating state by a motor during the replacement work-free order change.

What is claimed is:

1. A corrugated paperboard box making machine, comprising:
a sheet feeder that feeds out corrugated paperboard sheets one by one;
a printer that prints on the corrugated paperboard sheets;
a creaser unit that performs creasing on the corrugated board sheets;
a slotter unit that performs slotting on the corrugated board sheets; and
a controller configured to control the sheet feeder, the printer, the creaser unit, and the slotter unit,
wherein:
the sheet feeder comprises a feed-out mechanism that feeds out a lowermost corrugated paperboard sheet among corrugated paperboard sheets stacked in the sheet feeder, a feed roll that further feeds out the corrugated paperboard sheet fed out from the feed-out mechanism, a feed-out mechanism drive motor that drives the feed-out mechanism, and a feed roll drive motor that rotationally drives the feed roll; and
the slotter unit comprises an upper slotter to which a slotter blade that performs slotting on the corrugated paperboard sheet is attached, a lower slotter formed with a groove that is fittable with the slotter blade of the upper slotter, and a slotter drive motor that rotationally drives the upper and lower slotters,
wherein the controller is configured, when performing a replacement work-free order change in the corrugated paperboard box making machine, to:
after completion of production of a current order, control the feed-out mechanism drive motor to deactivate the feed-out mechanism so as to stop a corrugated paperboard sheet feeding operation, while controlling the slotter drive motor to enable the upper and lower slotters to continue rotating;
after completion of setup works which are preparatory works for production of a next order in the sheet feeder, the printer, the creaser unit, and the slotter unit, control the feed-out mechanism drive motor to drive the feed-out mechanism so as to resume the corrugated paperboard sheet feeding operation and start production of the next order; and
during a period from the completion of production of the current order to the start of production of the next order, control the feed roll drive motor to stop rotation of the feed roll before a sheet setting work in which an operator sets corrugated paperboard sheets in the sheet feeder and to resume the rotation of the feed roll after completion of the sheet setting work.

2. The corrugated paperboard box making machine according to claim 1, wherein, after the completion of the sheet setting work, the controller is configured to control the feed roll drive motor to resume the rotation of the feed roll before driving the feed-out mechanism for resuming the sheet feeding operation.

3. The corrugated paperboard box making machine according to claim 1, further comprising a die cutter that performs die-cutting on the corrugated paperboard sheets, wherein the controller is configured to control the feed roll drive motor such that the rotation of the feed roll is stopped before a last corrugated paperboard sheet of the current order passes through the die cutter.

4. The corrugated paperboard box making machine according to claim 1, wherein the controller is configured to determine whether or not the rotation of the feed roll has been stopped, and to permit performing the setup works which are the preparatory works, after determining that the rotation of the feed roll has been stopped.

5. The corrugated paperboard box making machine according to claim 1,
wherein the sheet feeder further comprises: a sheet feed table on which the corrugated paperboard sheets are stacked; a back guide that restricts rear ends of the corrugated paperboard sheets on the sheet feed table; and a back guide moving device that moves the back guide in a feed-out direction of the corrugated paperboard sheet, and
wherein the controller is configured to control the back guide moving device to move the back guide to a position according to a dimension of the corrugated paperboard sheets of the next order in the feed-out direction, within a period during which the controller operates, via the feed-roll drive motor, to cause the feed roll to undergo decelerating rotation so as to stop the feed roll.

6. The corrugated paperboard box making machine according to claim 1,
wherein the sheet feeder further comprises: a sheet feed table on which the corrugated paperboard sheets are stacked; a side guide that restricts opposite ends of the corrugated paperboard sheets on the sheet feed table in a width direction; and a side guide moving device that moves the side guide in the width direction, and
wherein the controller is configured to control the side guide moving device to move the side guide to a position according to a dimension of the corrugated paperboard sheets of the next order in the width direction, within a period during which the controller operates, via the feed-roll drive motor, to cause the feed roll to undergo decelerating rotation so as to stop the feed roll.

7. The corrugated paperboard box making machine according to claim 1,
wherein the sheet feeder further comprises: a sheet feed table on which the corrugated paperboard sheets are stacked; a back guide that restricts rear ends of the corrugated paperboard sheets on the sheet feed table; a side guide that restricts opposite ends of the corrugated paperboard sheets on the sheet feed table in a width direction; a back guide moving device that moves the back guide in a feed-out direction of the corrugated paperboard sheet; and a side guide moving device that moves the side guide in the width direction, and
wherein the controller is configured to:
control the back guide moving device to move the back guide to a position according to a dimension of the corrugated paperboard sheets of the next order in the feed-out direction and control the side guide moving device to move the side guide to a position according to a dimension of the corrugated paperboard sheets of the next order in the width direction, within a period during which the controller operates, via the feed-roll drive motor, to cause the feed roll to undergo decelerating rotation so as to stop the feed roll; and
control moving speeds of the back guide and the side guide via the back guide moving device and the side guide moving device, respectively, such that the movements of the back and side guides are completed at a timing when the rotation of the feed roll is stopped via the feed roll drive motor.

8. The corrugated paperboard box making machine according to claim 1, further comprising a notification device that notifies that the feed roll is undergoing decelerating rotation under the control of the feed roll drive motor by the controller.

9. The corrugated paperboard box making machine according to claim 1, further comprising a notification device that notifies that the rotation of the feed roll has been stopped under the control of the feed roll drive motor by the controller.

10. The corrugated paperboard box making machine according to claim 1, further comprising: a die cutter that performs die-cutting on the corrugated board sheets; a folder-gluer that applies adhesive and folds the corrugated board sheets to form a box-structured corrugated board sheet; and a counter-ejector that ejects the box-structured corrugated board sheets in units of given batches.
